(19) United States
(12) Patent Application Publication
(10) Pub. No.: US 2003/0006578 A1
(43) Pub. Date: Jan. 9, 2003

(54) Size-adjustable laterally-folding tilting-frame wheelchair

(75) Inventors: Mauricio Melgarejo, Simi Valley, CA (US); Alejandro Melgarejo, Simi Valley, CA (US); Tarcicio Melgarejo, Simi Valley, CA (US)

Correspondence Address: OPPENHEIMER WOLFF & DONNELLY, 2029 Century Park East, 38th Fl., Los Angeles, CA, 90067, US

(73) Assignee: Freedom Designs Incorporated

(21) Appl. No.: 10/198,299

(22) Filed: Jul. 17, 2002

Related U.S. Application Data
(63) Continuation-in-part of application No. 10/074,502, filed on Feb. 11, 2002.
(63) Continuation-in-part of application No. 09/191,422, filed on Nov. 12, 1998, now Pat. No. 6,345,833.
(63) Continuation-in-part of application No. 09/440,210, filed on Nov. 15, 1999.
(63) Continuation-in-part of application No. 09/438,343, filed on Nov. 11, 1999, now abandoned.
(63) Continuation-in-part of application No. 09/165,141, filed on Oct. 1, 1998, now abandoned.

(51) Int. Cl. B62B 3/02

(52) U.S. Cl. 280/250.1; 280/650; 280/657

(57) ABSTRACT

A wheelchair has a reclining seat that has a back portion and a bottom portion. The wheelchair also has a frame, which has a lower portion onto which wheels are attached and a substantially vertical portion extending upwardly from the lower portion. The back of the seat is attached to the substantially vertical portion of the frame. The wheelchair has a first mode for normal seating in which the substantially horizontal lower portion supports the bottom portion of the seat. The seat also has a second, reclined mode in which the seat is reclined backwardly relative to the normal position. The bottom and back portions of the seat and the substantially vertical portion of the frame are rotated together to tilt the seat into the reclined position. The lower portion of the seat is pivotally mounted on the lower portion of the frame, such that the lower portion of the frame remains substantially in place as the seat itself is tilted, and does not tilt with the seat. The seat may be removable from the frame, and the frame may be adapted to fold and/or collapse for compact storage. Alternative embodiments include features such as brackets that permit the seat back to slide relative to the back posts without the use of springs internal to the back posts. In another alternative embodiment, the seat is supported by members that rotate in conjunction with the back posts as the seat reclines.

This application is a continuation-in-part of U.S. application Ser. No. 10/074,502 filed Feb. 11, 2002 and U.S. application Ser. No. 09/191,422 filed Nov. 12, 1998, now U.S. Pat. No. 6,345,833. This application is also a continuation-in-part of U.S. application Ser. No. 09/440,210 filed Nov. 15, 1999, U.S. application Ser. No. 09/438,343, filed Oct. 11, 1999, and U.S. application Ser. No. 09/165,141, filed Oct. 1, 1998. All of these applications and patents are hereby incorporated by reference in their entirety into the present disclosure.

### BACKGROUND OF THE INVENTION

1. Field of the Invention

The present invention relates to wheelchairs and, more particularly, to wheelchairs in which the seat in which the user sits can be made to recline.

2. General Background and State of the Art

Wheelchairs are well known for providing persons of limited mobility with convenient means to get around. Two examples of wheelchairs are disclosed in U.S. Pat. Nos. 4,078,817 and 5,127,709, among many others. The typical wheelchair has a seat that is fixed in position relative to the chair frame, in that to put the user in a reclined position, the entire wheelchair must be tipped and held at an angle. This arrangement is inconvenient in many circumstances. For example, therapists must sometimes put a patient at an angle during therapy. It is difficult if not impossible to maintain a patient in a reclined position for an extended period of time in the classic type of prior art wheelchair.

FIG. 1 illustrates the frame 10 of an alternative wheelchair design in which the seat can be made to recline. To recline the seat, the operator squeezes a hand-operated squeeze mechanism 11, which permits the entire seat-support substructure (including base frame members 12a,b and backposts 14a,b) to rotate with one another. The seat (not shown) then rotates along with the seat-support substructure.

A drawback with the prior art design of FIG. 1 is that the support substructure is relatively heavy, and it is difficult for the operator to tilt the seat back and forth. A further drawback is that the frame is bulky and requires significant space for storage.

### INVENTION SUMMARY

The object of the present invention is to overcome one or more drawbacks present in the prior art.

In accordance with one aspect of the present invention, a wheelchair has a tiltable seat comprising a base frame comprising right and left base frame members. The wheelchair also includes a seat comprising a seat bottom and a seat back. A tiltable seat supporting frame has right and left back posts and right and left seat supporting members. The back posts are each interconnected with their respective seat supporting member. The tiltable seat supporting frame is pivotally mounted onto the base frame. The back posts each have a handle. The seat back is mounted onto the back posts and the seat bottom is mounted onto the seat supporting tubes. Right and left expandable lock mechanisms extending from a respective base frame member to a respective seat supporting member. The wheelchair frame includes the base frame and the tiltable seat supporting frame, the frame being laterally collapsible. A collapsible frame interconnects the right and left base frame members.

The collapsible frame comprises at least one cross member extending from one of the lower base frame members to the other of the upper base frame members. The cross member is pivotally mounted to a lower base frame member and an opposite upper base frame member.

In accordance with another aspect of the present invention, a wheelchair has a tiltable seat. The wheelchair has a base frame comprising right and left base frame members. A tiltable seat supporting frame comprising right and left back posts and right and left seat supporting members. The back posts are each releasably interconnected with their respective seat supporting member, the tiltable seat supporting frame being pivotally mounted onto the base frame. The back posts each have a handle, the seat back being mounted onto the back posts and the seat bottom being mounted onto the seat supporting tubes. The wheelchair has right and left expandable lock mechanisms, each extending from a respective base frame member to an adjacent seat supporting member. The wheelchair has a frame comprising the base frame and the tiltable seat supporting frame, the frame being laterally collapsible. The backposts are foldable onto the seat supporting tubes.

The wheelchair may have an in-use configuration in which the back posts are locked in a fixed relationship relative to the seat supporting tubes, and a folded configuration in which the backposts are unlocked from the seat supporting tubes and are folded forward onto the seat supporting frame.

In accordance with one specific embodiment, a wheelchair having a tiltable seat has a base frame comprising right and left lower base frame tubes and right and left upper base frame tubes. The wheelchair seat has a seat bottom and a seat back. The bottom of the seat is supported by a tiltable seat supporting frame. The tiltable seat supporting frame has right and left back posts and right and left seat supporting tubes. The tiltable seat supporting frame is pivotally mounted onto said base frame, the back posts each having a handle. The seat back is releasably mounted onto the back posts and the seat bottom is releasably mounted onto the seat supporting tubes. Releasable right and left locking bracket mechanisms interconnect the right and left back posts with right and left seat supporting tubes, respectively. Right and left releasable lock mechanisms, each having a retractable extension arm, extending from a respective upper base frame member to a respective seat supporting tube. The back post handle includes a release handle and a release cable extending from the release handle to the releasable lock mechanism. The wheelchair has a frame comprising the base frame and the tiltable seat supporting frame, the frame being laterally collapsible and the backpost being foldable onto the seat supporting tube. The frame has an unfolded configuration in which the back posts are locked by the locking bracket mechanisms in a fixed relationship relative to the seat supporting tubes, and a folded configuration in which said backposts have been released from said locking bracket mechanisms and are folded forward onto the seat supporting frame. A collapsible frame interconnects the right and left base frame members, the collapsible frame comprising at least one cross member extending from one of the lower base frame members to the other of the upper base frame members. The cross member being pivotally mounted to the respective lower base frame and upper base frame members.

This embodiment may also have right and left tilt tube support brackets, which each extend between a respective upper base frame member and a tiltable chair supporting member. Each of the brackets has a pin that extends through an upper base frame member such that upper base frame member is adapted to pivot about the pin.

The collapsible frame may also include first and second cross members, right and left upper cross-member mounting brackets hingedly mounted on respective right and left upper base frame tubes and right and left lower cross-member mounting brackets mounted on respective right and left lower base frame tubes. The first cross member extends from the mounting bracket on the right lower base frame member to the mounting bracket on the left upper base frame member. The second cross member extends from the mounting bracket on the left lower base frame member to the mounting bracket on the upper right base frame member.

The wheelchair frame may also be free of welds.

A further embodiment of the present invention relates to a mechanism that permits the back of the seat to slide relative to the back posts as the seat is reclined. In this embodiment, the seat supporting frame is typically stationary, with the seat being pivotally mounted to the seat supporting frame. The seat then rotates backwardly as the user pulls back the back posts, with a seat back mounting bracket sliding relative to a back post as the seat reclines. The back posts may be fitted with plastic sheaths along which the seat back mounting brackets slide as the seat is inclined. The seat back mounting brackets may each include a roller that rolls along a back post as the seat is inclined, to smoothly accomplish the sliding function.

Many other objects and features of the invention will become apparent from a review of the Detailed Description below, from the drawings, and from the claims.

### BRIEF DESCRIPTION OF THE DRAWINGS

FIG. 1 is a perspective view of a prior art wheel chair frame in which the entire seat frame rotates as a unit in order to recline the chair;

FIG. 2 is a perspective view of one embodiment of a wheelchair according to the present invention;

FIG. 3 is a side elevation view of the wheelchair of FIG. 2;

FIG. 4 is a front elevation view of the wheelchair of FIG. 2;

FIG. 5 is a rear elevation view of the wheelchair of FIG. 2;

FIG. 6 is a detail cut-away view illustrating a compression spring mechanism within a backpost;

FIG. 7 illustrates a user squeezing the handles and reclining the seat and backrest together into a reclined position;

FIG. 8 illustrates the wheelchair with the seat reclined;

FIG. 9 is a perspective view of a second embodiment of the present invention, with the seat removed;

FIG. 10 is a rear elevation of the wheelchair of FIG. 9;

FIG. 11 is a front elevation of the wheelchair of FIG. 9;

FIG. 12 is a detail view of Area 12 of FIG. 9;

FIG. 13 is a detail view illustrating the seat mounted upon the frame;

FIG. 14 is a rear elevation view illustrating the wheelchair in a partially folded configuration;

FIG. 15 is a detail view of Area 15 of FIG. 9;

FIG. 16 is a detail view illustrating the bracket of FIG. 15 having been rotated into a position to receive a backpost to place the wheelchair in a folded configuration;

FIG. 17 illustrates an embodiment of the present invention in a fully folded configuration;

FIG. 18 is a detail view taken at Area 18 of FIG. 11 illustrating a quick release mechanism for releasing the seat from the backposts;

FIG. 19 is an alternative embodiment of the present invention;

FIG. 20 is a detail view of Area 20-20 on FIG. 19;

FIG. 21 is a detail view of the mechanism of FIG. 21 in an open configuration;

FIG. 22 is a top view of the mechanism of FIG. 21 in the open configuration;

FIG. 23 is a detail view of the seat hinge;

FIG. 24 is detail view of FIG. 23 with the seat partially removed;

FIG. 25 is a perspective view of an alternative embodiment of the present invention, in which a seat supporting frame rotates relative to the base frame as the seat is reclined;

FIG. 26 is a perspective view of the embodiment of FIG. 25 showing an attendant squeezing the release handles in preparation to recline the seat;

FIG. 27 is a perspective view showing the wheelchair in a reclined configuration;

FIG. 28 is a detail view of a back post;

FIG. 29 is a detail view showing the seat back releasably mounted to a back post;

FIG. 30 is a detail view showing a back post releasably interconnected with a seat supporting tube;

FIG. 31 is a detail view from another angle showing the back post interconnected with the seat supporting tilt tube;

FIG. 32 is a detail view of one side of the base frame and a seat supporting member;

FIG. 33 is a detail view showing a seat supporting tilt tube pivotally mounted by way of a bracket and pin to an upper base frame tube member;

FIG. 34 is a detail view of a tilt porter mechanism having an extendable arm, the mechanism interlocking an upper base frame tube with a seat supporting tilt tube, the extendable arm extending when the tilt porter mechanism is unlocked and as the seat supporting tilt tube is rotated upwardly;

FIG. 35 is a detail view of the weld-free frame, which is similar to a design disclosed in U.S. patent application Ser. No. 09/191,422, filed on Nov. 12, 1998 and incorporated by reference herein;

FIG. 36 illustrates the embodiment of FIG. 25 with the removable seat having been removed from the wheelchair;

FIG. 37 is a detail view of the rotatable mounting bracket that interconnects a collapsible cross-frame member to an upper base frame tube;

FIG. 38 illustrates an attendant folding one of the back tubes down onto a seat supporting tube;

FIG. 39 illustrates the wheelchair frame in a fully collapsed and folded compact configuration;

FIG. 40 illustrates the bottom of the removable seat; and

FIG. 41 illustrates the back of the removable seat.

FIG. 42 illustrates the size adjustability of the frame.

FIG. 43 is a section of a prior art welded sideframe;

FIG. 44 is a perspective view of a wheelchair frame in accordance with the present invention;

FIG. 45 illustrates the interface between the upper and the lower portions of the sideframe;

FIG. 46 illustrates an axle plate as used in a presently preferred embodiment of the invention;

FIG. 47 illustrates an axle extension plate as used in a presently preferred embodiment of the invention;

FIG. 48 illustrates a presently preferred castor plate;

FIG. 49 is an exploded view of a connector member and associated end pieces for joining the left and right sideframe portions;

FIG. 50 is a detail view of an end piece; and

FIG. 51 illustrates an alternative plate for use in a major-wheel-forward embodiment of the present invention.

### DETAILED DESCRIPTION OF THE PREFERRED EMBODIMENTS

While the specification describes particular embodiments of the present invention, those of ordinary skill can devise variations of the present invention without departing from the inventive concept.

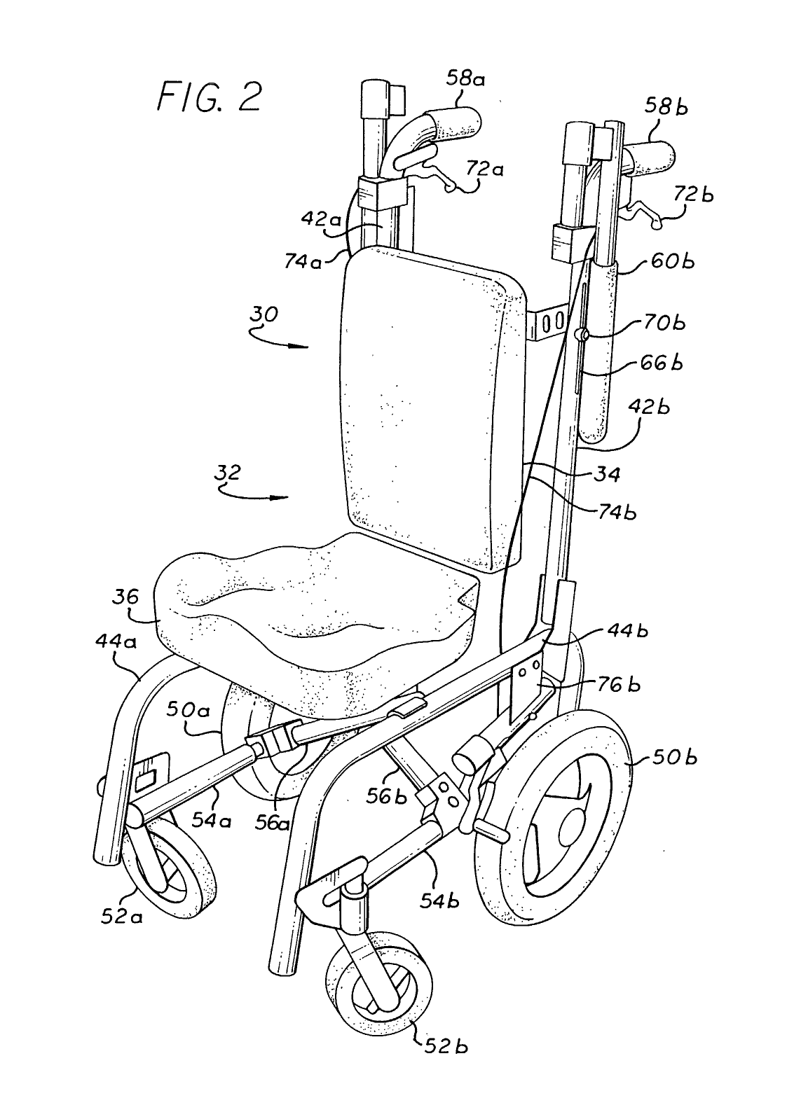

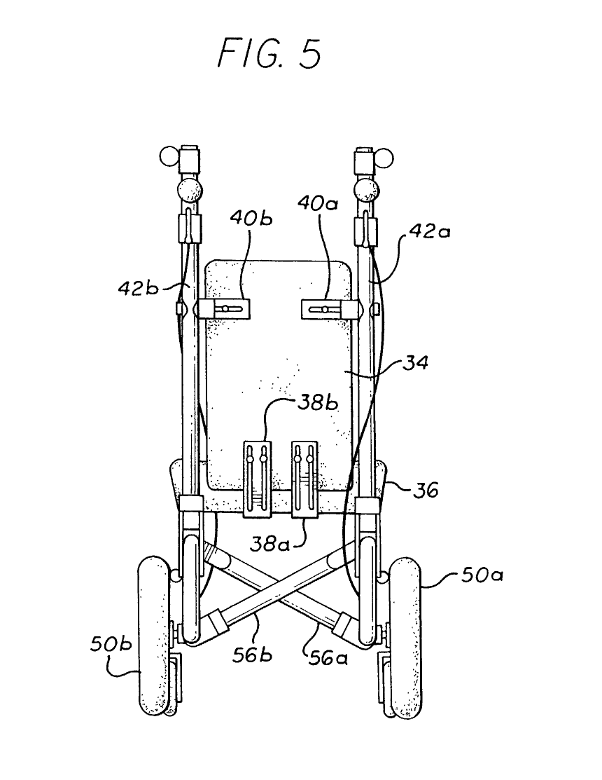

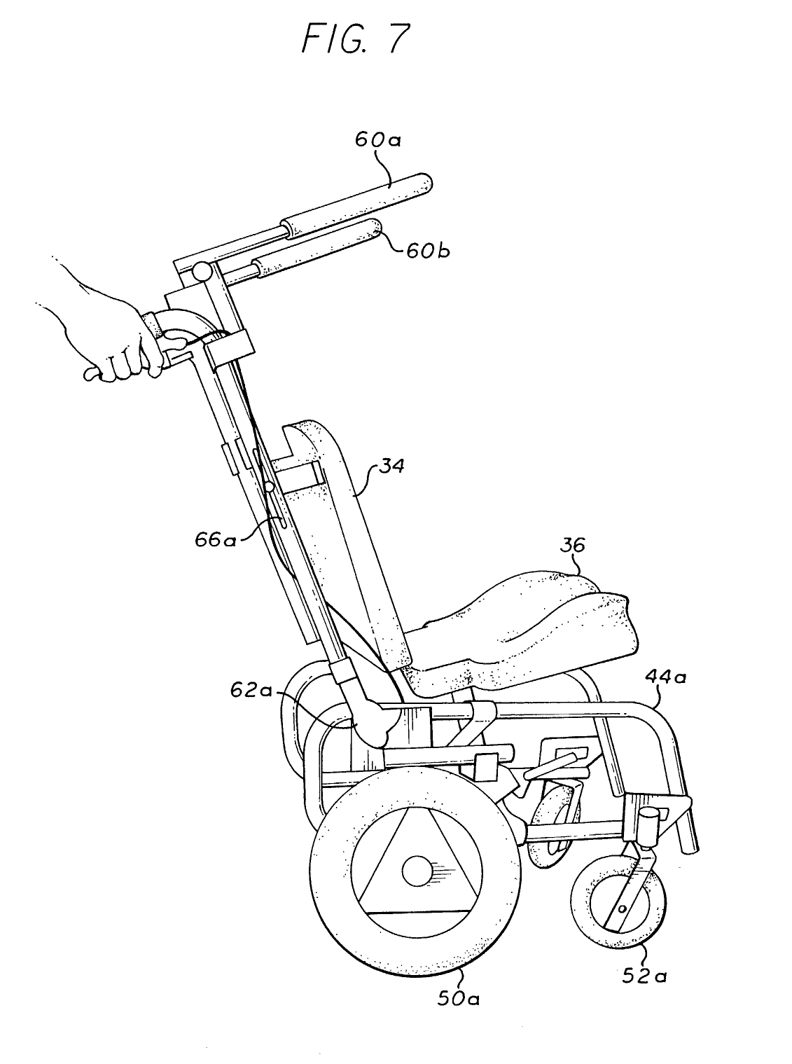

Considering now a particular preferred embodiment of the present invention, FIG. 2 illustrates one illustrative example of a wheelchair having a reclining seat. The wheelchair 30 includes a seat 32 having an upper cushion 34 and a lower cushion 36. FIG. 5 illustrates that the seat 32 also includes brackets 38A and 38B that interconnect the rear of upper cushion 34 with the bottom of lower cushion 36. The brackets 38A and 38B hold cushions 34 and 36 at a fixed angle relative to one another. Brackets 40A and 40B attach to the back of upper cushion 34 and interconnect with spring-loaded backposts 42A and 42B, respectively, to secure upper cushion 34 to the frame of the wheelchair. The lower seat cushion 36 rests upon upper base frame members 44A and 44B, respectively, when the seat is not reclined. However, the lower seat cushion is rotatably to the base frame members 44A and 44B and is free to rotate upwardly as illustrated in FIG. 7.

The wheelchair also includes various features that are standard in the art such as relatively larger rear wheels 50A and 50B and relatively small front wheels 52A and 52B. Lower base frame members 54A and 54B are interconnected with upper base frame members 44A and 44B, respectively, by way of cross braces 56A and 56B. Push handles 58A and 58B, which may include a resilient material grip that is conventional in the art, are provided at the generally horizontally extending upper portions of backposts 42A and 42B, respectively.

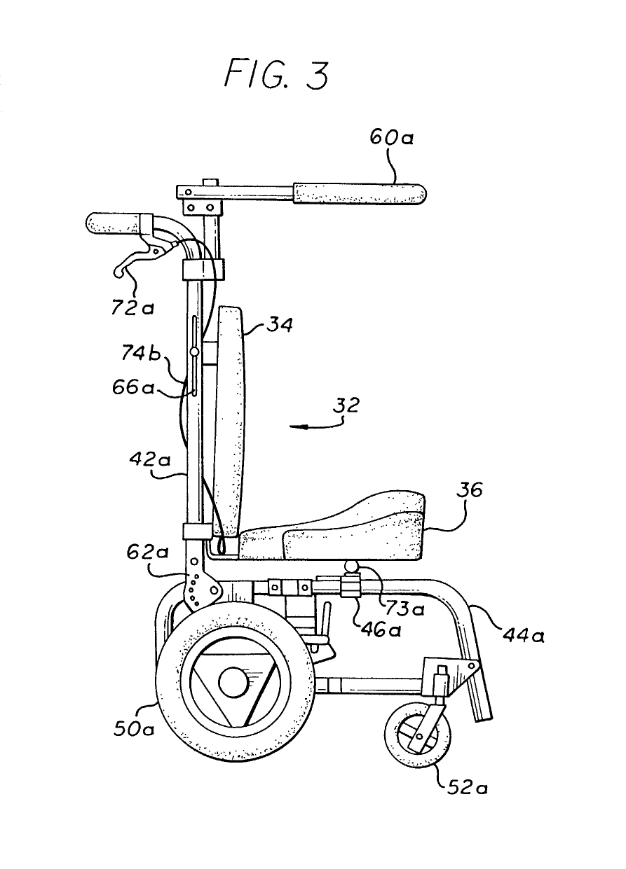

The wheelchair may also be provided with flip canopy support posts 60A and 60B that are rotatably mounted onto the upper portion of the backposts 42A and 42B, respectively. The canopy support members are normally placed in the configuration illustrated in FIG. 2 in which no canopy extends over the seat 32. However, as illustrated in FIG. 3, the flip canopy support post may be rotated upwardly to extend above the seat 32. A canopy (not shown) may be extended between canopy supports 60A and 60B to provide shade to the user in sunny, outdoor conditions. The feature of the canopy above the wheelchair seat is conventional in the wheelchair art. Alternatively, in certain embodiments of a wheelchair according to the present invention, supports 60A and 60B may be adjusted downwardly on the respective backposts 42A, B to become adjustable locking flip back armrests that may be locked into a horizontal configuration to support the arms of the person in the wheelchair.

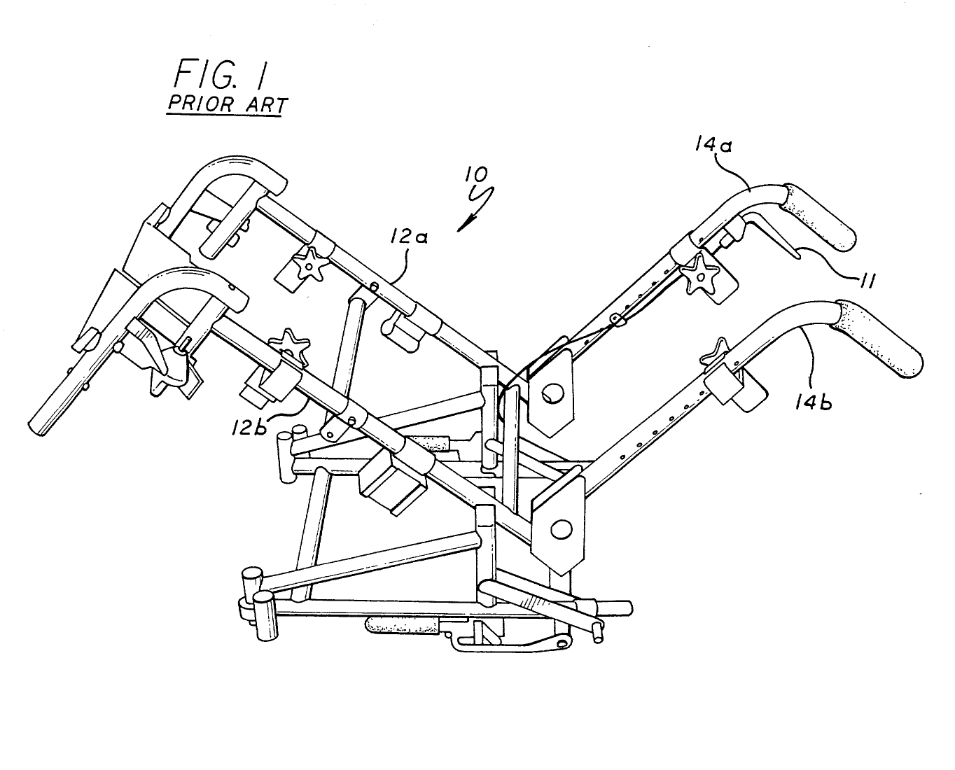

A unique feature of one preferred embodiment of the present invention relates to the manner in which the seat can be tilted backwards in order to put the user in a reclined position. As will be recalled from FIG. 1, reclining wheelchairs are designed such that the entire supporting frame that supports the seat rotates upwardly with the lower seat cushion as the seat reclines.

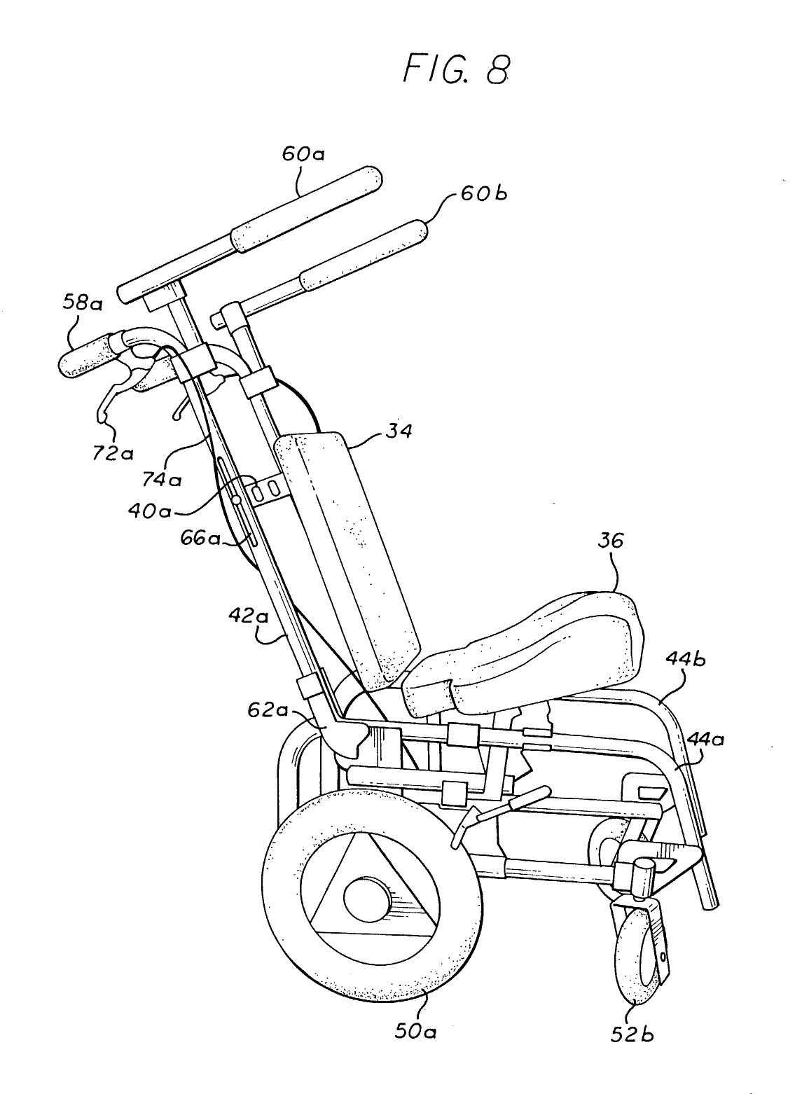

In the preferred embodiment of the present invention, the base frame members 44A and 44B do not rotate with the lower seat cushion 36 as the seat is reclined. Rather, the lower seat cushion 36 tilts upwardly independently of the position of the base frame members 44A and 44B, which are generally fixed into a set position. As FIG. 8 illustrates, the backposts 42A and 42B recline backwardly in conjunction with rear seat cushion 34 as the seat reclines. In particular, the backposts 42A and 42B are rotatably interconnected with the lower portion of the wheelchair frame by means of bracket assemblies 62A and 62B.

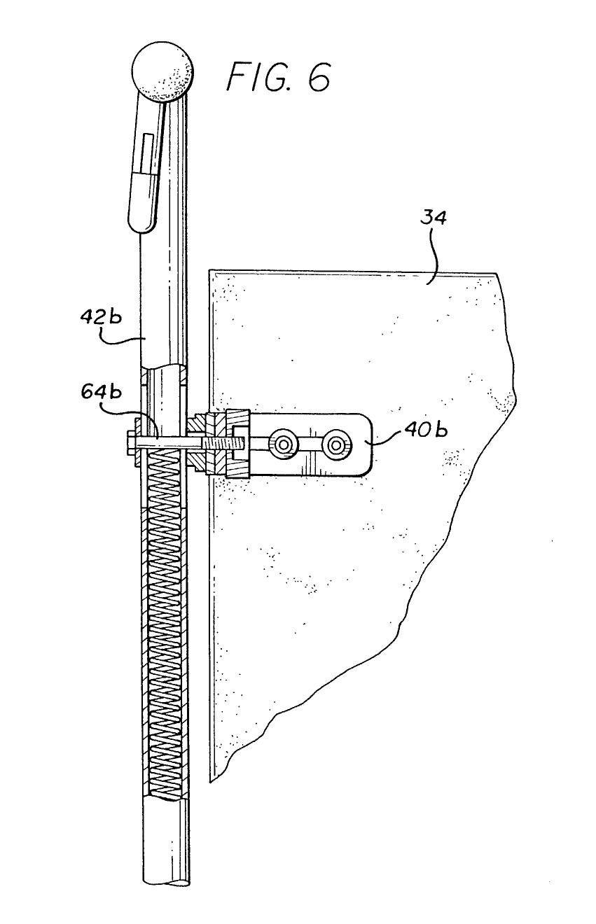

As illustrated in FIG. 6 and in FIG. 3, for example, a bolt 64B extends from bracket 40B and through 66B and 68B in backposts 42B. The bolt is secured to the outside of the member 42B by means of a standard bolt head and washer arrangement or, alternatively and preferably, by a knob that the user can tighten or untighten as desired. Such a knob is illustrated in FIG. 2, for example, as member 70B.

Referring in particular to FIG. 6, a compression spring 72B is provided within backpost 42B. The compression spring is held into place by means of one or more roll pins (not shown). As the seat 32 reclines backwardly, the bolt 64B slides down the slots 66B and 68B respectively, thereby compressing compression springs 72B. A similar compression spring 72A and associated bolt is provided within structural member 42A. As the bolt 64B travels downwardly in the slots 66B and 68B, the compression spring 72B is compressed. These compression springs 72A and 72B perform at least two functions. One function is to ease the rate of recline as the chair is being put into the reclining position. The compression springs 72A and 72B serve to make the reclining motion somewhat more gentle than if there was no compression spring within the structural members 42. Methods of mounting compression springs within a tube are known in the art such as, for example, mounting roll pins within the tube at one or both ends of the compression spring.

Another function of the compression springs 72A and 72B is to assist the operator in returning the seat to the non-reclined position of FIG. 2, for example, from the reclined position of FIG. 8. There will typically be someone sitting in the seat 32 when the chair is being rotated from the reclined position back to the non-reclined position, and the weight of the user can make it somewhat difficult to rotate the seat. However, the compression springs 72A and 72B apply an upward pressure on the respective bolts 64A and 64B, thereby assisting the user in rotating the seat back from the reclined to the non-reclined position.

As FIG. 7 illustrates, as the chair 32 reclines, the members 42A and 42B move in parallel with rear cushion 34 while the lower cushion 36 rotates upwardly and independently of the base frame members 44A and 44B. The lower cushion is supported by a two support rods 73A and 73B (FIG. 3) that are mounted on the underside of the lower cushion. The support rods are removably mounted in a sleeve, and rotate within the sleeve as the chair reclines. The cushion 34 and the lower cushion 36 are held at a fixed angle relative to one another such that they rotate in unison. It should be noted that, as illustrated in FIG. 5, the two cushions 34 and 36 can be adjusted to be closer or farther from one another simply by adjusting the bracket 38A and 38B. Similarly, the position of the upper cushion 34 can be adjusted relative to the structural members 42A and 42B by adjusting the position of the brackets 40A and 40B. The brackets are typically attached to the back of the seat by way of screws or bolts that can be secured by any means known in the art.

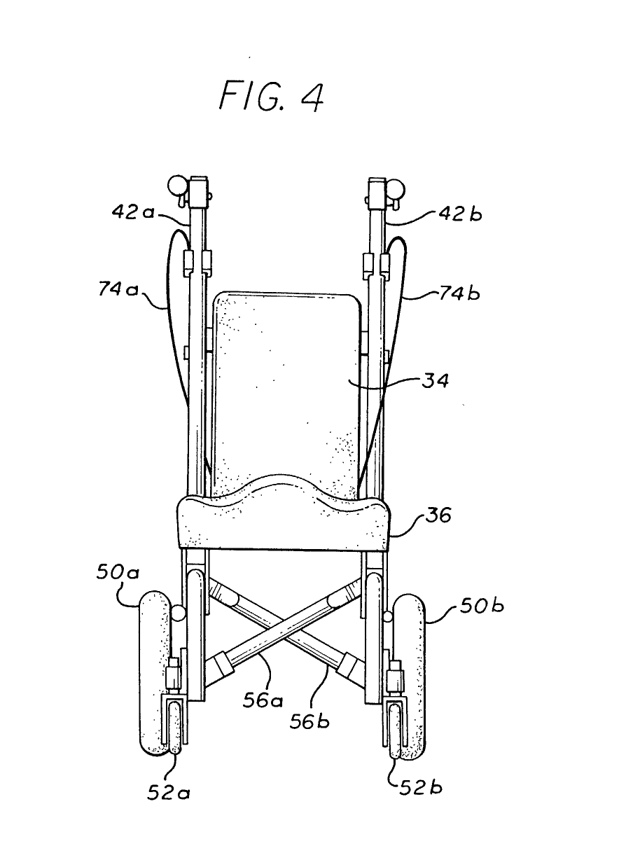

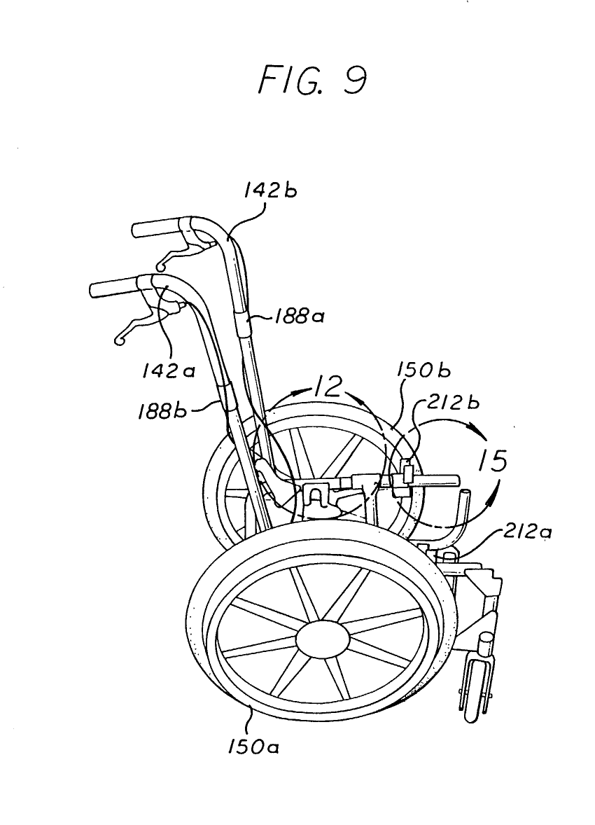

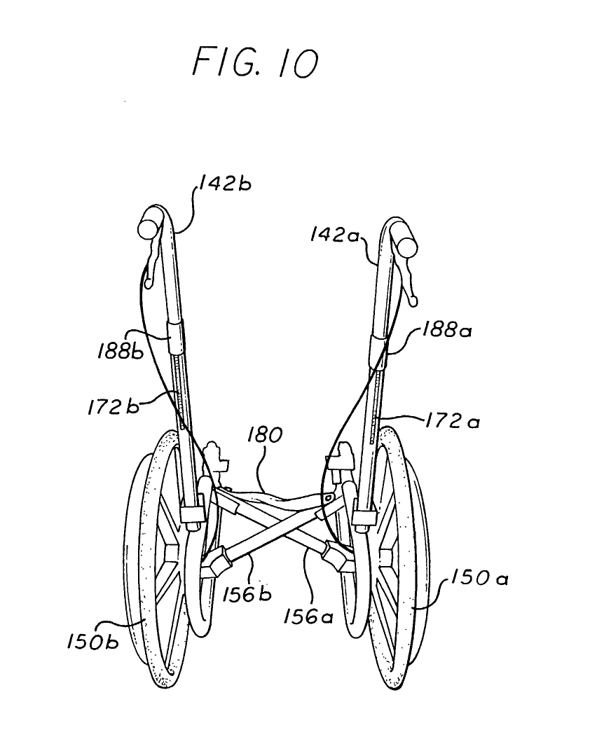

FIGS. 9-16 illustrate a second embodiment of the present invention. FIG. 9 is a perspective view of a second embodiment of a wheelchair according to the present invention, with the seat removed. Generally speaking, the parts of the wheelchair are numbered in a manner consistent with FIGS. 2-8, with an additional 100 added to each reference numeral. The wheelchair has independently movable backposts 142a and b. The backposts are loaded with compression springs 172a and b (FIG. 10), which are held in place within the tubes with roll pins (not shown). Movable plastic sleeves 188a and b are mounted on the backposts 142a and b. The plastic sleeves are movable up and down on the respective backposts, such that as a plastic sleeve is moved downwardly, the respective compression spring compresses.

As in the embodiment of FIGS. 2-8, the base frame includes cross braces 156a and 156b extending between upper and lower base frame members. The cross braces are fixedly but rotatably attached to the lower base frame members, and are attached to the upper base frame members by rotating armatures that permit the cross braces to separate from the upper base frame as the chair is folded.

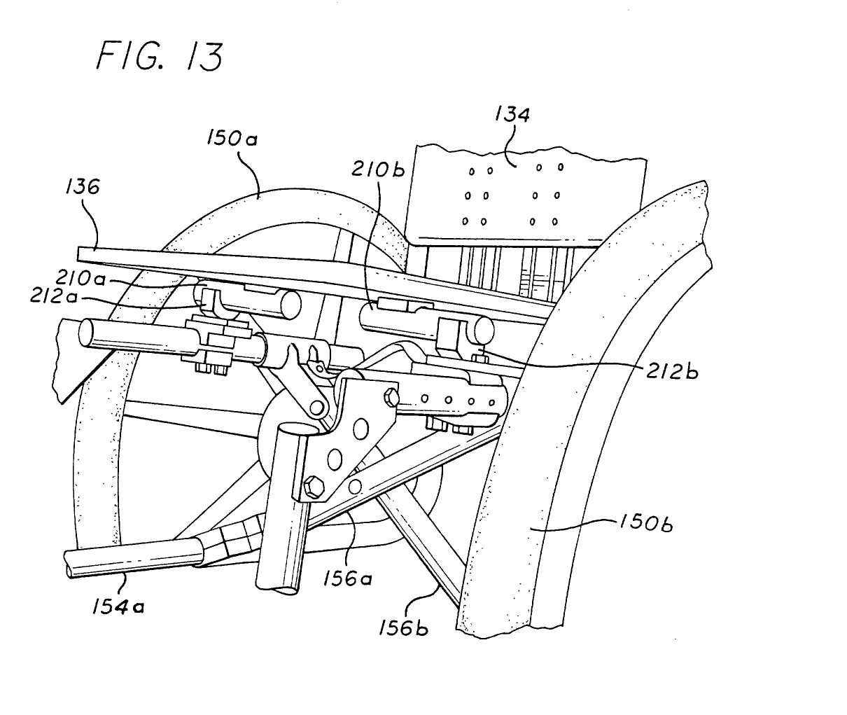

The locking mechanisms of the embodiments of FIGS. 2-8 and FIGS. 9-13 are very similar and will be explained with reference to both embodiments. Returning to FIG. 2, the wheelchair is provided with handle bar squeeze mechanisms, 72A and 72B, which are connected to cables 74A and 74B, respectively, which are in turn connected to mechanical locks 76A and 76B. The squeeze handle system operates analogously to hand brakes on a bicycle. Mechanical locks 76A and 76B can be of the type known as “Mechlock,” which are known in the art. When the user squeezes the hand squeeze unit 72A and 72B, the wires 74A, 74B are pulled and the mechanical locks 76A and 76B are released. The user can then move the backposts 42A and 42B backwards and forwards to put the chair in a reclined position, to return the chair to the normal position from a reclined position, or to hold the unit into the configuration of FIG. 13 when the seat has been removed.

However, when the user has not squeezed the hand squeeze units 72A, 72B the backposts 42A and 42B are locked into place. Consequently, the user can sit in a particular position on the chair without fear that the chair will rotate forwardly or backwardly when not intended. The system further permits the operator to tilt the chair to the extent desired, and to tilt and lock the chair to any tilt position. Arrangements other than the mechanical lock and hand squeezed system illustrated in FIG. 2 may be employed.

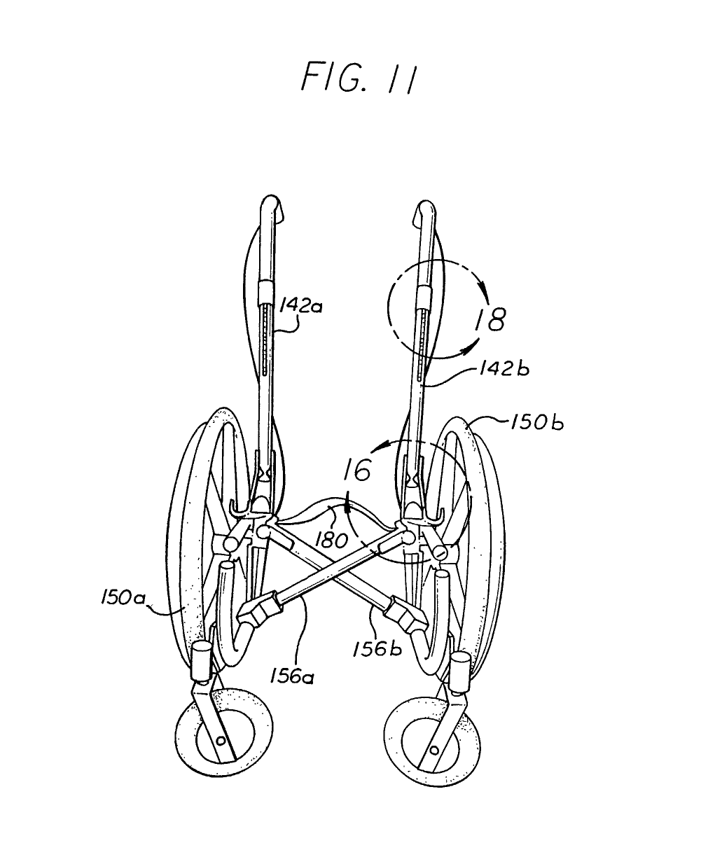

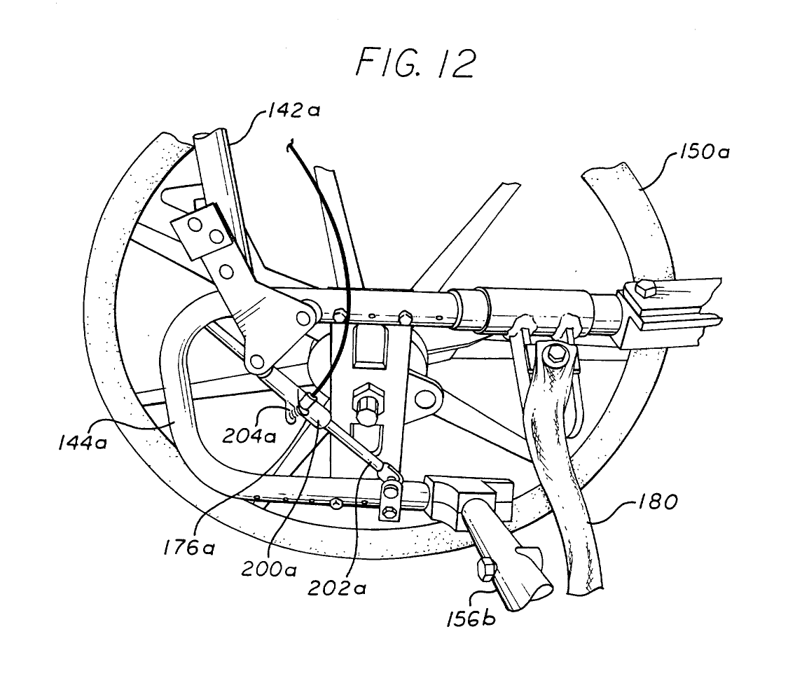

The mechanical lock is illustrated in greater detail in FIG. 12, which illustrates the second embodiment of the present invention. The lock 176a includes a movable housing 200a that is free to move along rod 202a when the user squeezes the respective squeeze lever 172a. Squeezing the squeeze lever 172a compresses compression spring 204a, which in turn releases the lock. As the user then pulls back on the backpost 142a while continuing to squeeze the squeeze lever 172a, the housing 200a of the lock is forced downwardly along the rod 202a. The seat rotates backwardly with the backpost 142a (assuming that the user reclines backpost 142b simultaneously). To lock the seat into position, the user releases the squeeze lever, which then causes the mechanical lock 172a to lock in place on the rod 202a.

FIG. 13 illustrates how the seat is rotatably mounted onto the base frame of the wheelchair. Two cylindrical tubes 210a and b are attached to the underside of the seat. The cylindrical tubes are removably mounted onto female receptacles on sleeves 212a, b. The cylindrical tubes 210a and b are free to rotate within the sleeves 212a, b, such that the angle of the seat can be adjusted back and forth. The receptacles on sleeves 212a, b are generally open, such that the seat can be lifted off of the sleeves when the user pulls up on the seat.

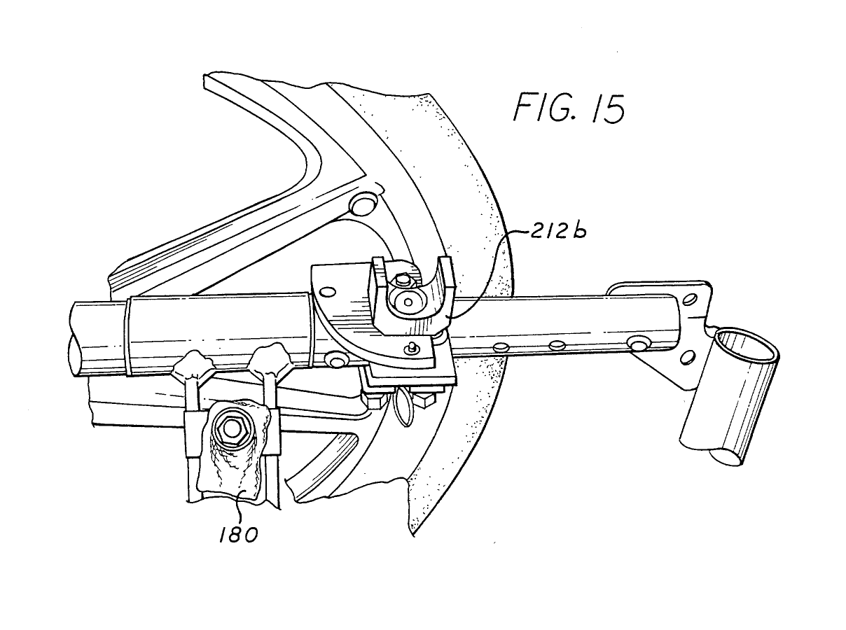

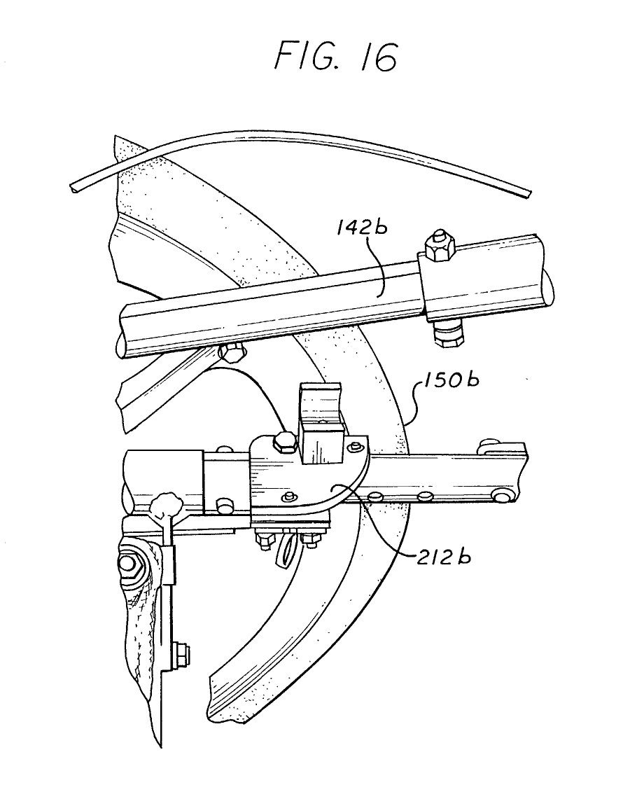

The sleeves are themselves mounted on a pivoting bracket, which can be locked into place or can be rotated 90 degrees. FIG. 15 illustrates one arrangement in which the sleeve 212b is locked into a position for mounting the seat onto the base frame. FIG. 16 illustrates the same sleeve 212b having been rotated 90 degrees for the purpose of accepting the backpost 142b. The diameter of the backpost 142b is selected such that the backpost 142b can snap into the sleeve 212b in order to hold the backpost 142b into a folded position, and can be snapped out of the sleeve 212b for normal use of the wheelchair. The sleeve 212b is locked into position by use of a spring-loaded pin, as is conventional in the art.

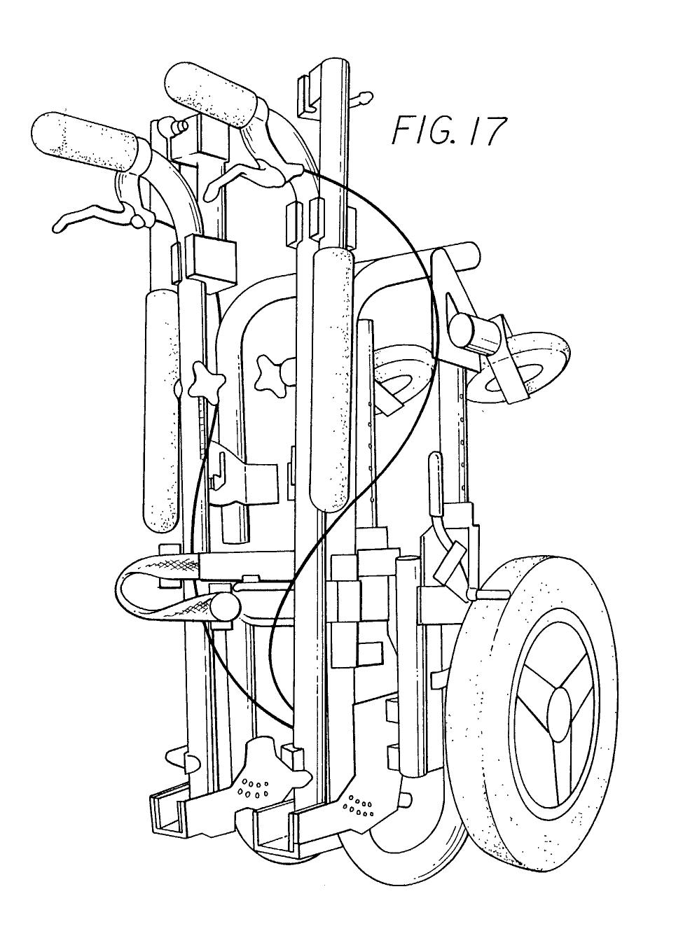

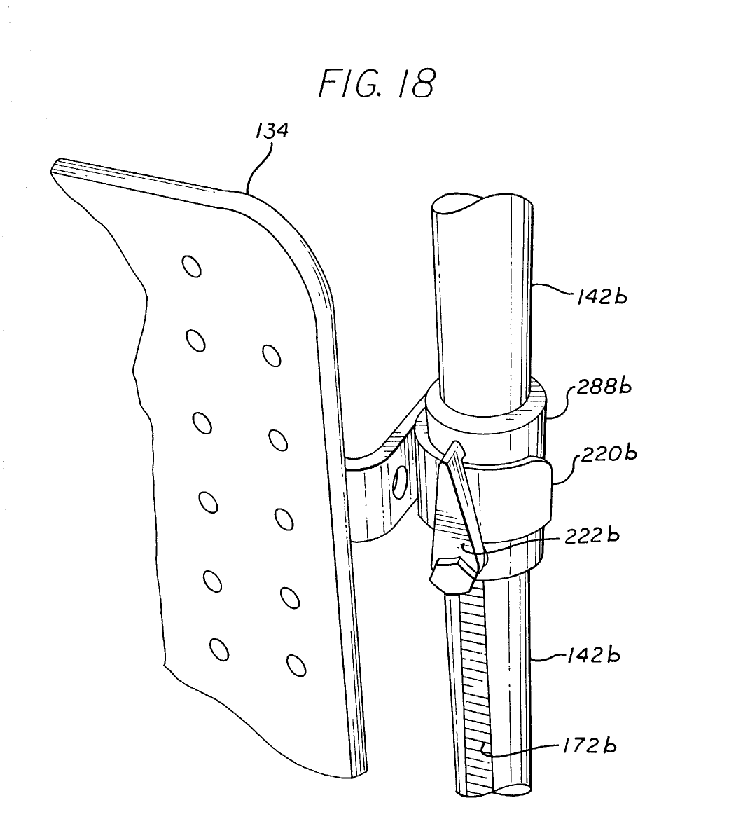

Another inventive feature of the preferred embodiment of the present invention relates to folding the frame into a compact configuration that is easy to store. FIG. 10 illustrates the frame itself after the chair has been removed. The chair is mounted onto the backposts 142a,b by way of a hook/sleeve combination. In particular, referring to FIG. 18, the hook bracket 220b fits onto the outer surface of a plastic sleeve 188b. The hook bracket is held in place by means of a quick release handle 222b. To release the seat from engagement with the backpost 142b, the user rotates the handle 142b in a clockwise direction until the handle no longer holds the hook in place. An identical arrangement is provided on the opposing side of the seat, employing backposts 142a, quick release handle 222a, and a sleeve 188a (not shown). The hook bracket/quick release handle arrangement permits the chair to be removed from the wheelchair frame so that the frame can be folded.

The frame is provided with a flexible handle strap 180 having ends that are attached to the wheelchair frame. The handle 180 is typically made of a flexible non-stretched material such as ¾ inch width nylon. As FIG. 11 illustrates, the cross braces 156A and 156B are rotatably attached to lower base frame members 154A and 154B respectively, which are mounted on rotating brackets 182A and 182B, respectively. The members 156A and 156B are rotatably connected to the horizontal portions of base frame members 144A and 144B respectively, by means of rotating armatures 184A and 184B, respectively. As the user pulls up on the handle 180, the cross-members 156a,b lift up off the members 144A and 144B as the armatures 184A and 184B rotate upwardly. Similarly, the lower brackets 182A and 182B rotate to allow the cross braces 156A and 156B to rotate into a generally vertical configuration. As the user continues to pull on handle 180, the frame collapses horizontally as FIG. 12 illustrates. To fold the wheelchair into an even more compact configuration, the user can further rotate the vertically extending members 142A and 142B into the configuration of FIG. 13. The wheelchair is then in a highly compact configuration for storage or transport, as illustrated in FIG. 17, which relates in particular to the embodiment of FIGS. 2-8 but generally to both embodiments described herein.

As for dimensions, those skilled in the art will recognize that chairs of the embodiment illustrated may be made in any of the variety of sizes for a variety of different users. For example, small chairs may be made for children, while much larger chairs may be made for adults. Consequently, the specific dimensions of any one embodiment will depend upon the size of the intended end user. Those skilled in the art will also recognize that the various structural components must have sufficient dimension and material strength characteristics so as to make the chair structurally sound. The specific dimensions and material strength characteristics of the wheelchair are not specifically an inventive feature of the present invention, and those skilled in the art will know how to employ structurally sound members to make a safe wheelchair.

The foregoing has described a presently preferred embodiment of the invention, as well as alternative embodiments. However, it should be understood that the scope of the invention is not limited to what is described in the Detailed Description. Numerous variations may be employed within the scope of the invention. For example, the back posts can be connected directly to the seat rather than to the base frame.

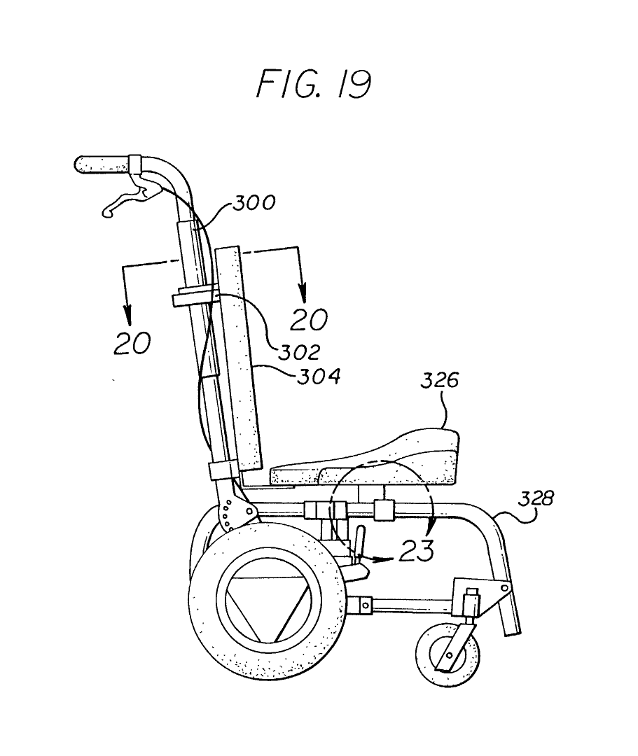

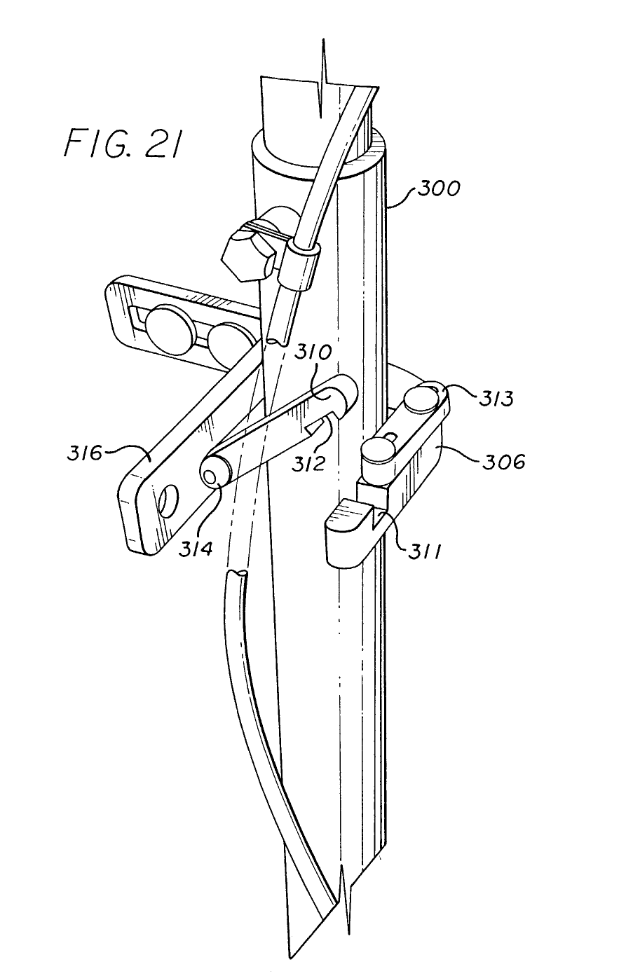

Considering additional variations on the invention, FIGS. 19-24 illustrate an alternative embodiment in which the rear of the seat slides relative to the back posts as the seat is reclined backwardly. This removes the need to use springs that are internal to the back posts. Referring to FIG. 19, a plastic sheath 300 encompasses a portion of each respective back post. A bracket 302 that is interconnected with seat back 304 is engaged about the plastic sheath 300. When the seat is reclined, the bracket slides relative to the plastic sheath 300.

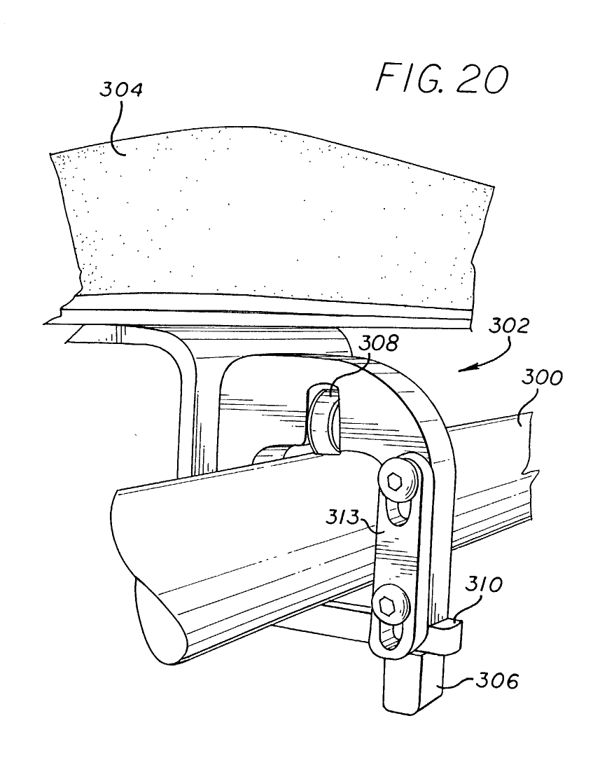

FIG. 20 illustrates the arrangement in more detail. The bracket has a roller 308 that rolls relative to the plastic sheath 300 as the seat is reclined. The bracket also has an arm 306 that engages with a rotating arm 310. Arm 306 includes a detent 311, while arm 310 includes a detent 312. The detent 312 is adapted to engage with detent 311 when arm 310 is rotated downwardly. A locking member 313 is slidably mounted on arm 306 to selectively lock the arm 310 into place, as in FIG. 20.

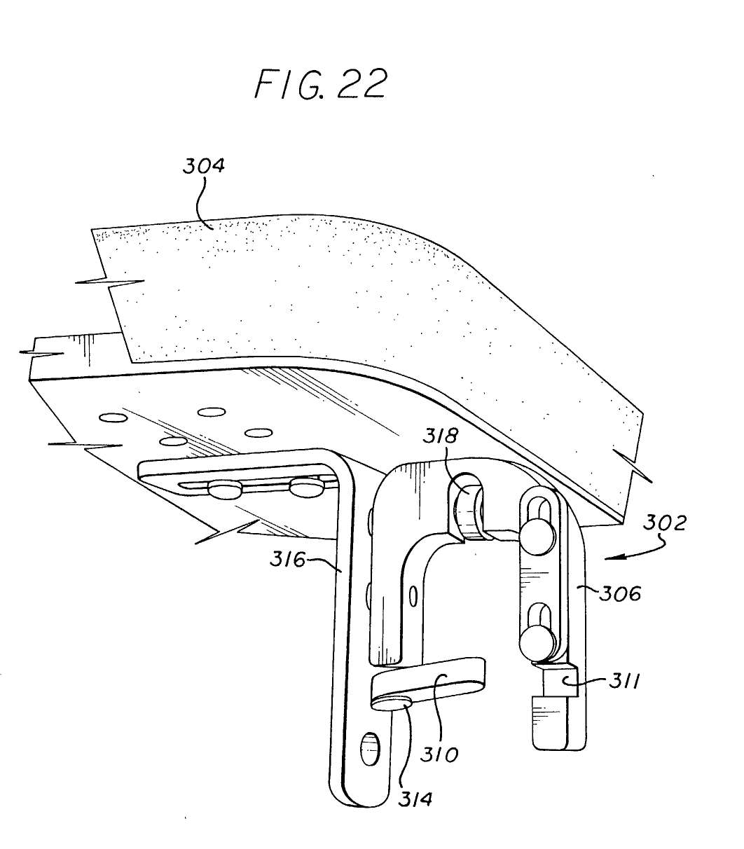

The rotating arm 310 rotates about a pin member 314 that extends through arm 310 and into the adjoining portion of the bracket 302. As seen in FIG. 22, the bracket 302 is itself mounted to an L-shaped bracket 316, which is mounted to the back of the seat 304.

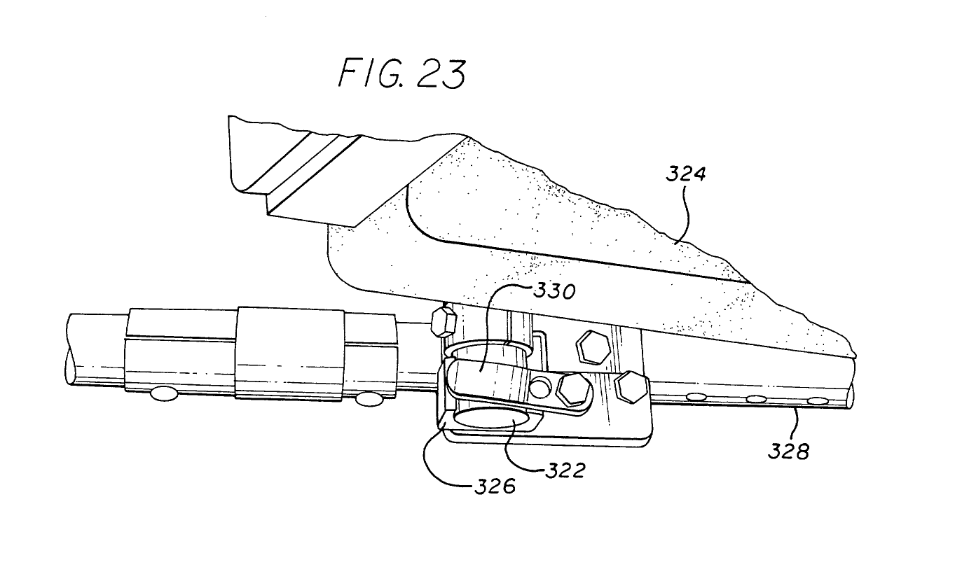

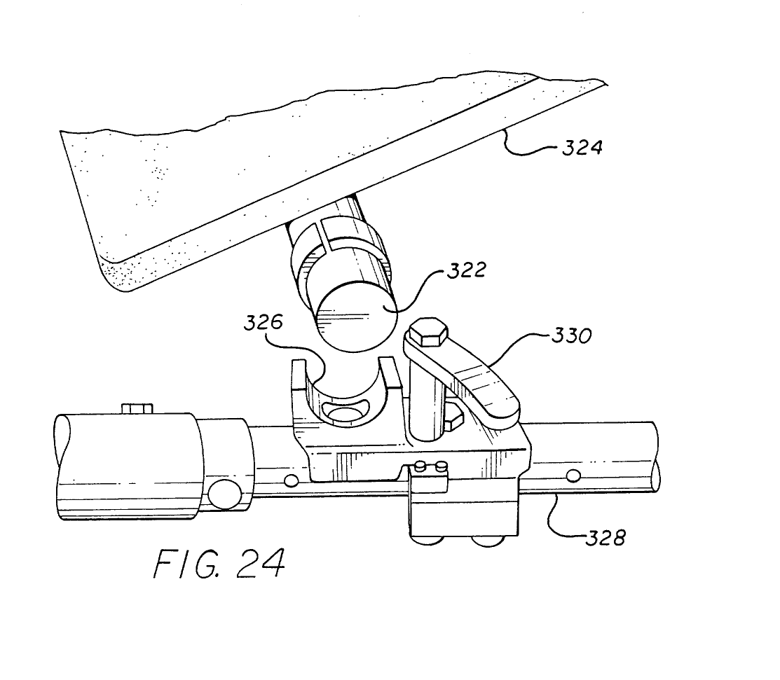

FIG. 23 illustrates a mounting member 322 that is rotatably mounted onto a seat-supporting portion of the frame. The tubular member 322 extends from and is attached to the underside of seat bottom 324. Mounting member 322 engages with a compatibly-shaped receiving member 326, which is mounted on seat-supporting frame member 328. A locker arm 330 rotates to selectively maintain the tubular member 322 in the receiving member 326, as in FIG. 23. The seat can be removed from the seat-supporting frame when the locker arm 330 is rotated into an unlocked position 330, as in FIG. 24.

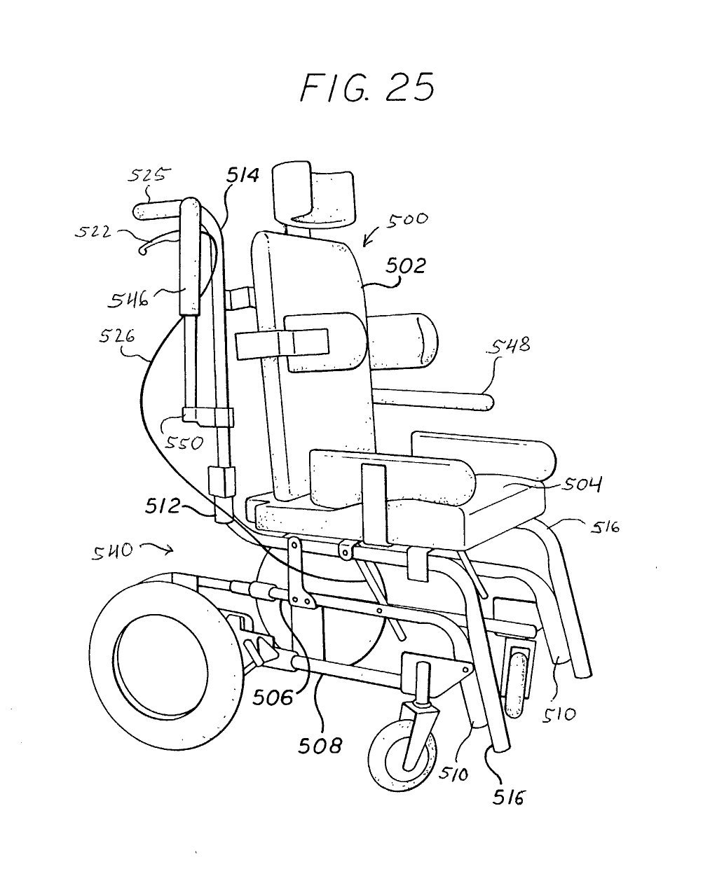

In accordance another embodiment that FIGS. 25-41 illustrate, a wheelchair has a tiltable seat 500. The seat includes a seat back 502 and a seat bottom 504. A base frame 506 includes right and left lower base frame tubes 508 and right and left upper base frame tubes 510. The bottom of the seat is supported by a tiltable seat supporting frame 512. The tiltable seat supporting frame 512 has right and, left back posts 514 and right and left seat supporting tubes 516.

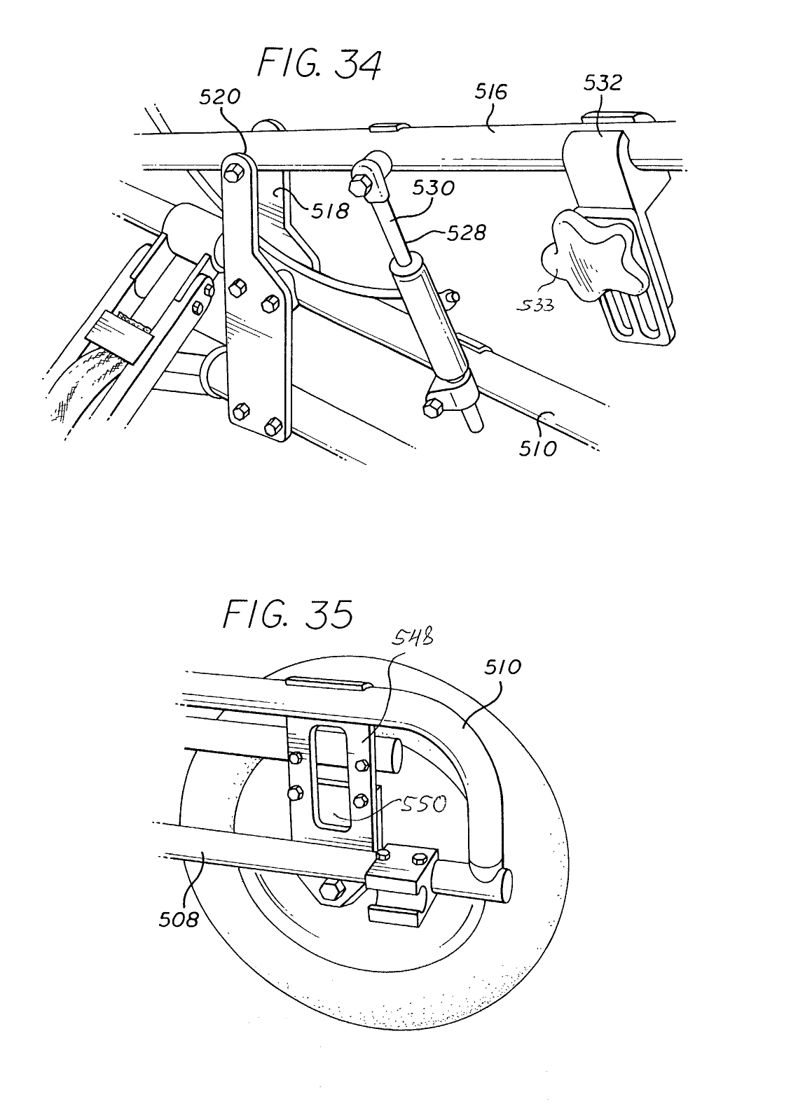

The tiltable seat supporting frame 512 is pivotally mounted onto the base frame 506. Referring to FIG. 33, a tilt tube support bracket 518 extends from the upper base frame tube to a pivot point 520 on the seat supporting tilt tube. A pin extends through the bracket 518 and the tilt tube 516, such that the tilt tube 516 rotates about the pin as the seat reclines. FIG. 34 illustrates the tilt tube having been rotated about the pivot pin into a reclined position.

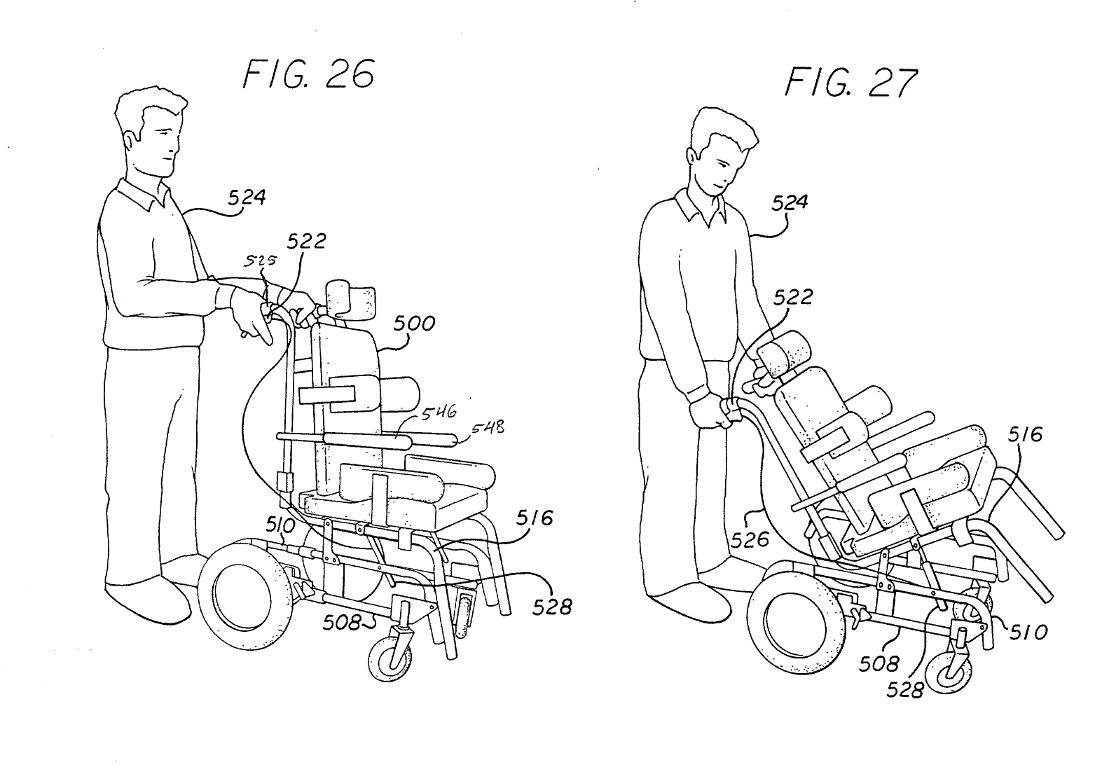

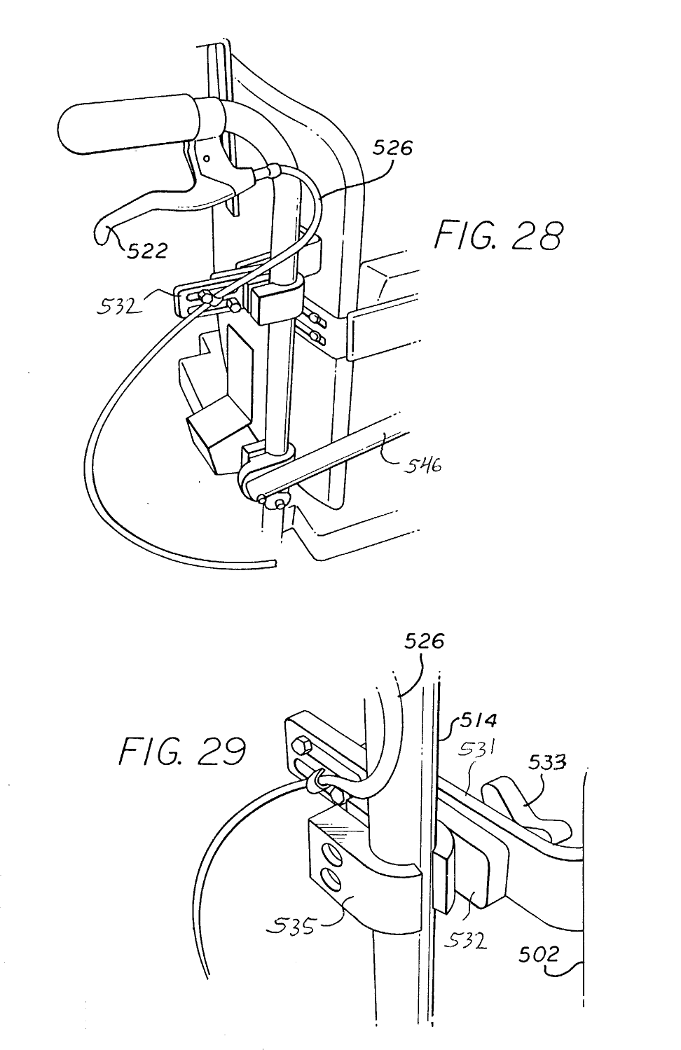

As described in the previous embodiments, the back posts each has a handle 525 with a release lever 522 mounted thereon. To recline the seat, the attendant 524 first squeezes the release levers (FIG. 26) to tighten respective release cables 526 (FIG. 28). The release cables 526 extend from the levers to mechanical locking mechanisms 528 (FIGS. 27, 33 and 34) of the sort that are conventional in the art. When the cables are tightened, the mechanical locking mechanisms 528 are disengaged, and the seat is free to rotate into a reclined position, or from a reclined position to a non-reclined position, as desired. Each mechanical locking mechanism has an extendible and retractable arm 530 that extends when the mechanical locking mechanism is disengaged and the attendant is reclining the seat (FIG. 34). the arm retracts when the mechanical locking mechanism is disengaged and the attendant rotates the seat forward (FIG. 33). When the seat is in the desired position, the attendant releases the levers to again engage the mechanical locking mechanisms. The seat is then fixed into position. FIGS. 26 and 27 illustrate how an attendant puts the seat into a reclined position.

Considering the mechanical locking mechanism in more detail, and referring to FIG. 34, right and left releasable lock mechanisms are mounted on a respective upper base frame member 510 and extend to a respective seat supporting tube 516. In particular, the extendable arm 530 is mounted to the seat supporting tilt tube 516. Consequently, the arm 530 extends when the seat supporting tube 516 reclines, and retracts when the seat supporting tube 516 is lowered. This particular embodiment of a locking mechanism serves to maintain the relative positions of the seat supporting tube and the upper base frame tube, and to interconnect the seat supporting structure with the base frame.

FIG. 25 shows an armrest 546 in a raised position and an armrest 546 in a lowered position. The arm rests 546 are secured to the posts 514 by mounting clamps 550.

The seat back is releasably mounted onto the back posts and the seat bottom is releasably mounted onto the seat supporting tubes. The seat of the present embodiment has different mounting brackets than the seat illustrated in FIG. 18 in conjunction with another embodiment of the invention. FIGS. 40 and 41 illustrate the multiadjustable “L” mounting brackets 531 on the bottom 504 and rear 502 of the seat, respectively. The brackets are mounted onto seat mounting mechanisms such as illustrated in FIGS. 29 and 34 with reference numeral 532. The attendant tightens the bracket against the seat by rotating the screw-type handle 533 of the mechanism. FIG. 29 illustrates the seat back mounted onto a seatmounting bracket 532, with the handle having been rotated to secure the seat in place.

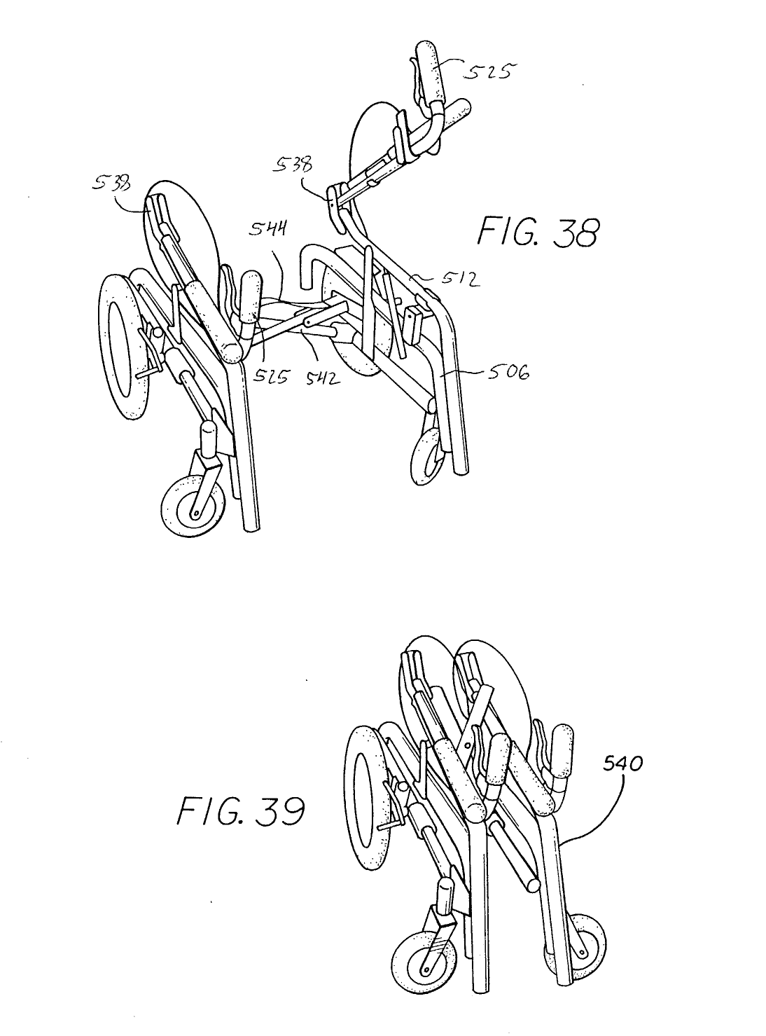

FIGS. 30 and 31 illustrate that releasable right and left locking bracket mechanisms 534 interconnect the right and left back posts 514 with right and left seat supporting tubes 516, respectively. Each locking bracket mechanism includes a spring biased back post release lever 536 that extends from its respective back post 514. The base of the lever is mounted within the post as is a compression spring that biases the lever downwardly. The portion of the lever 536 that extends form the back post has a step, which serves as a locking surface. The post locking system also includes a release lever locking bracket 538 that is mounted on and extends from the seat supporting tube 516. As FIG. 30 illustrates, the step of the release lever 536 abuts a surface of the release lever locking bracket 538, to lock the back post 514 into position relative to the seat supporting tilt tube 516. To unlock the back post 514 from the seat supporting tilt tube 516, the user lifts the release lever 536 to overcome the bias force of the compression spring, and rotates the back post 514 forward, as FIG. 38 illustrates. The back post 514 is mounted with a pin into the seat supporting tilt tube 516, thereby allowing the back post 514 to rotate back and forth relative to the tube 516 when the locking bracket mechanism 534 is disengaged.

The frame 540 of this particular embodiment comprises the base frame 506 and the tiltable seat supporting frame 512. The frame is laterally collapsible and the backpost is foldable onto the seat supporting tube. The mechanisms for laterally collapsing and folding the backposts have already been described in detail above in connection with the first-described embodiment of the invention. To summarize, the frame 540 has an unfolded configuration in which the back posts are locked by the locking bracket mechanisms in a fixed relationship relative to the seat supporting tubes (FIG. 1). The frame 540 also has a folded configuration in which the backposts have been released from the locking bracket mechanisms and are folded forward onto the seat supporting frame (FIG. 39). A flexible collapse strap 544 is utilized in the same manner as handle 180 described above.

As illustrated in FIGS. 30, 31 and 32, the right and left seat supporting tubes 516 have approximately a 35 degree bend at the end proximate the left and right back posts 514, respectively. As illustrated in FIG. 27, the bends in the seat supporting tubes 516 and the distance between the base frame 506 and the seat supporting tubes 516 are such as to allow the seat supporting frame to tilt through at least a 25 degree range.

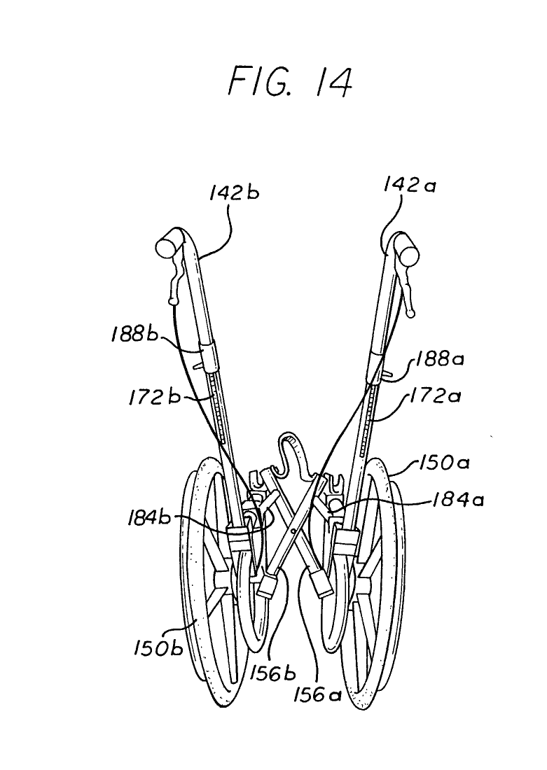

A collapsible cross-frame 542 interconnects the right and left base frame members 506 to make the wheelchair frame collapsible, in the manner previously described in conjunction with FIG. 14. The collapsible frame 540 has at least one cross member extending from one of the lower base frame members 508 to the opposite upper base frame member 510. The cross member 542 is pivotally mounted to the respective lower base frame 508 and upper base frame members 510. The collapsible frame 540 may also include first and second cross members, right and left upper cross-member mounting brackets 543 hingedly mounted on respective right and left upper base frame tubes 510 and right and left lower cross-member mounting brackets 545 mounted on respective right and left lower base frame tubes 508. The first cross member extends from the mounting bracket on the left lower base frame member 508 to the mounting bracket on the upper right base frame member 510.

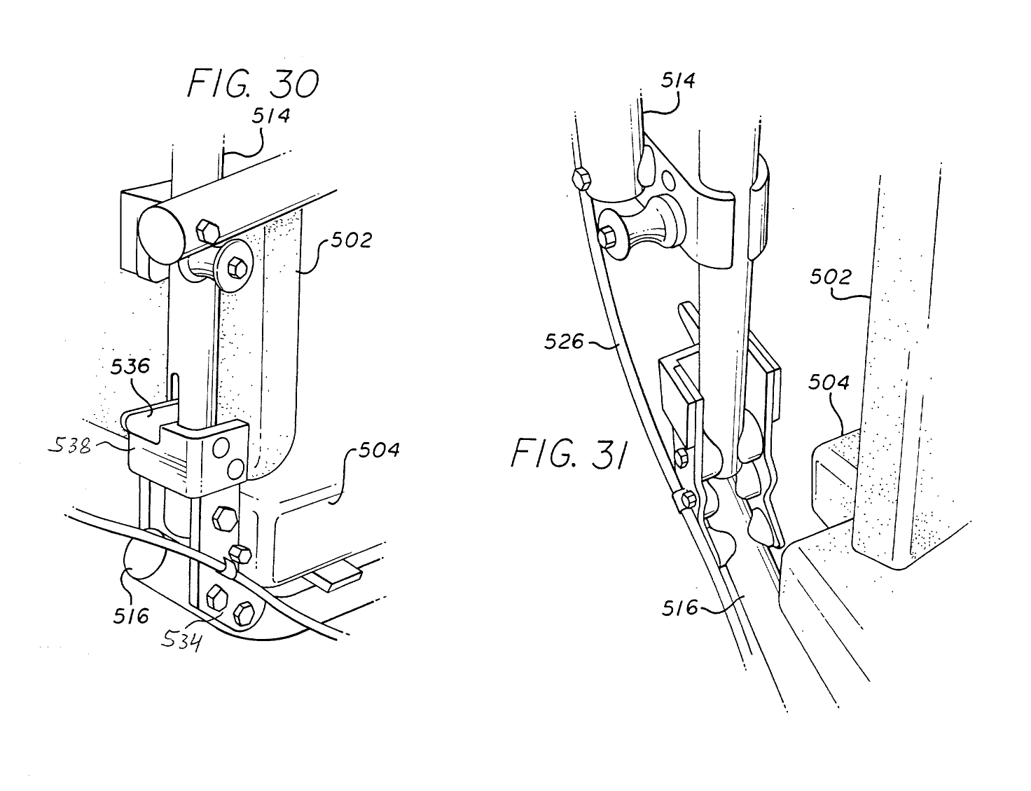

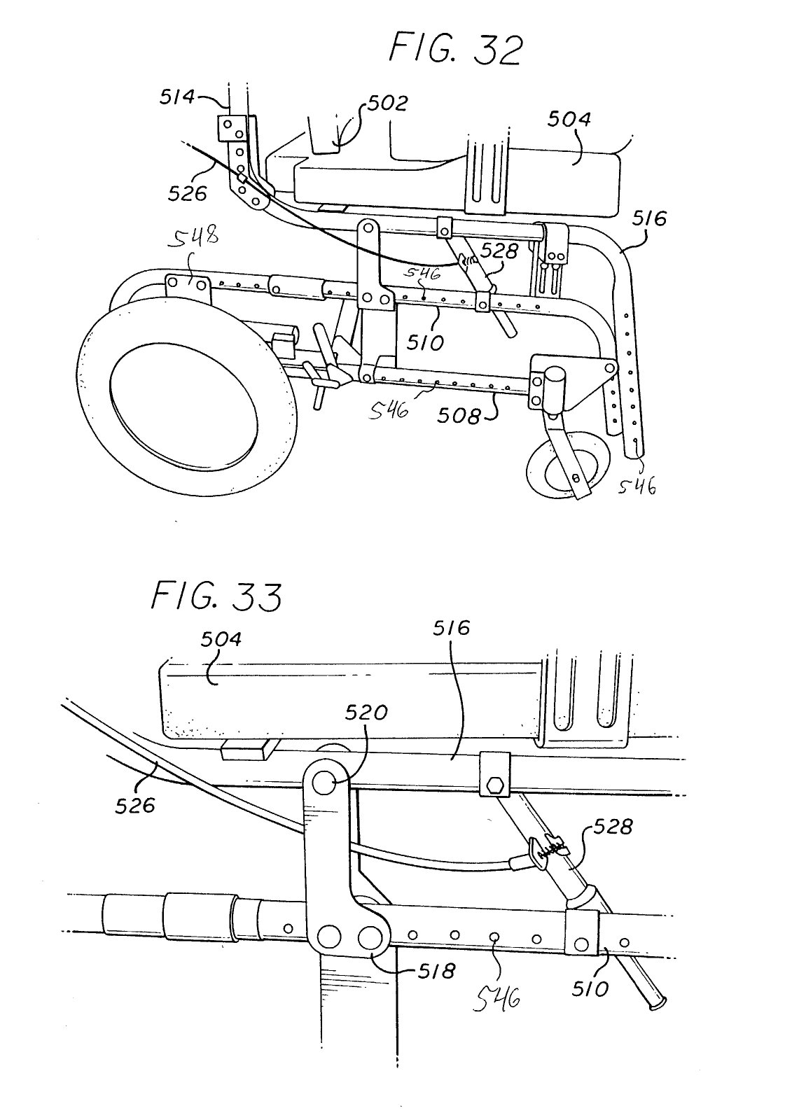

As illustrated in FIG. 32, a plurality of tube mounting apertures 546 are disposed along the lower base frame tubes 508, upper base frame tubes 510 and seat supporting tilt tubes 516. FIG. 35 illustrates an axle plate 548 used to secure the rear wheel to the base frame 506. Also shown is an axle extension plate 550. The axle plate 548 is secured to the base frame 506 using bolts passing through the mounting apertures.

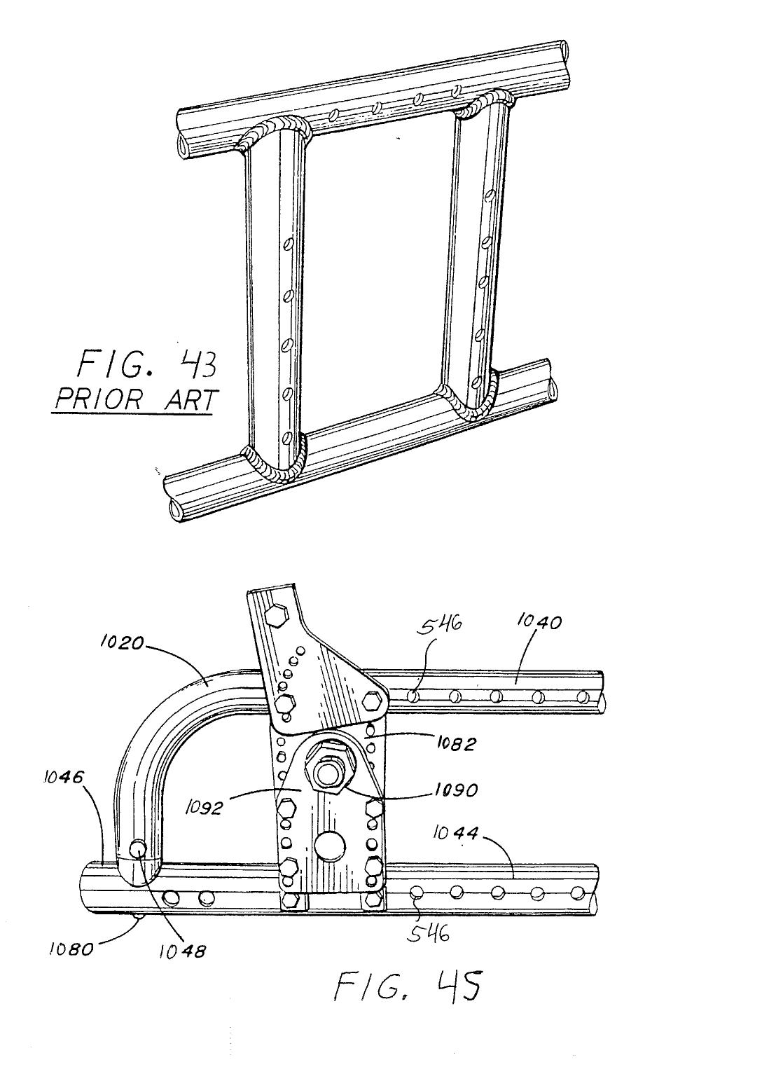

The axle plate 548 of FIG. 35 can be replaced with the axle plate 1082 and axle extension plate 1092 described below with respect to FIG. 45. In addition, the frame 540 can be modified to allow any of the adjustments of the extension plate 1082 relative to the frame 540 described herein.

The preferred embodiments of the wheelchair frames according to the present invention are free of welds. The weld-free frame technology is discussed in detail in U.S. patent application Ser. No. 09/191,422, filed on Nov. 12, 1998 and incorporated by reference herein. The weld-free design generally results in a more durable, less costly to produce, and lighter weight design than designs found in the prior art.

Referring to FIG. 44, a wheelchair 1010 has left and right wheels 1012 and 1014 and a seat 1016. A lower frame 1018 includes a left side frame 1020 and a right side frame 1022. Small forward wheels 1024 and 1026 extend from casters 1028 and 1030 respectively. A single piece footrest 1032 extends between the left and right footrest hangers 1034 and 1036, respectively.

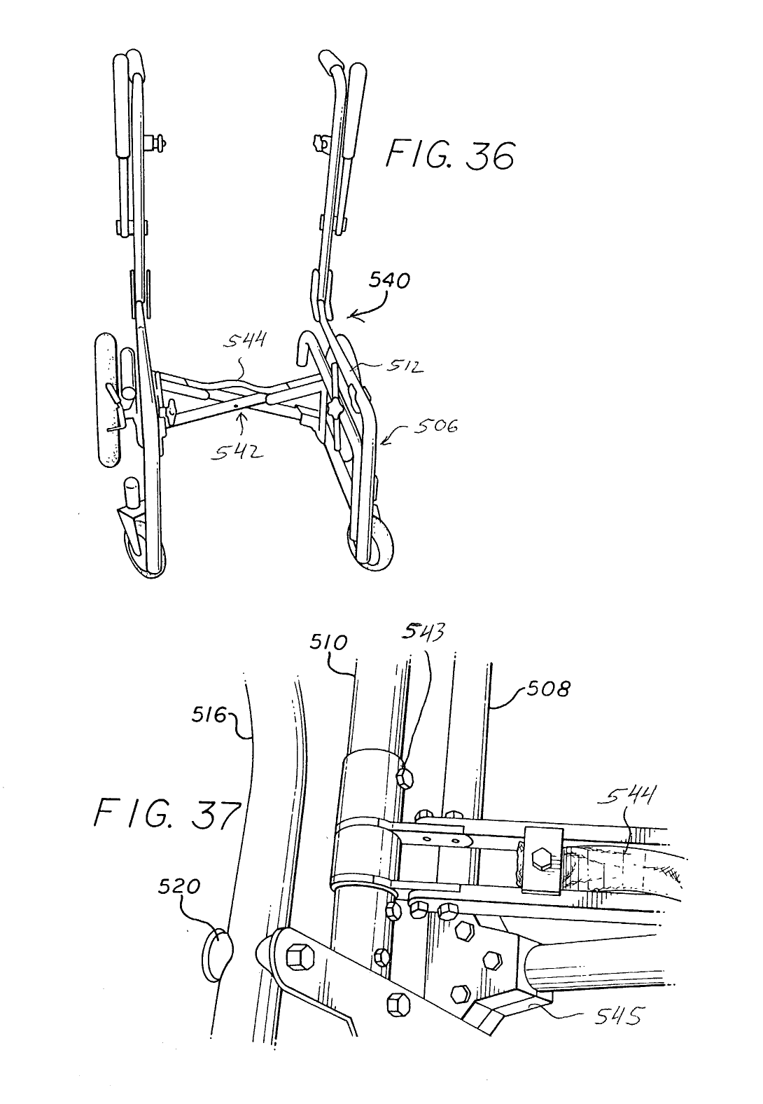

Each of the side frames 1020 and 1022 have respective upper frame members 1040 and 1042, respectively, and lower sideframe members 1044 and 1046, respectively. The lower frame members 1044,1046 are spaced by spacer members 1050 and 1052, respectively. The upper frame members 40 and 42 are spaced and interconnected by spacer bar 54. Alternatively, the left side frame 1020 and a right side frame 1022 can be separated by the collapsible cross-frame 542 of FIG. 36 or the cross-cross braces 156A and 156B of FIG. 14.

The wheelchair is stabilized by anti-tip members 1160 and 1162, respectively, each of which is generally a rearwardly extending member having stabilization wheels. These anti-tip members 1160 and 1162 prevent the wheelchair from tipping backwards during use.

The respective upper and lower sideframe members are interconnected without the use of welds. Considering the left sideframe, and referring to FIG. 45, the upper frame portion 1040 and the lower frame portion 1044 are interconnected at a juncture point 1046. The upper member 1040 in the preferred embodiment is a tubular member that is hollow inside. Tubular members for wheelchair frames are well-known in the art, although a presently preferred embodiment of the invention incorporates tubular members having a diameter of 1″ and a wall thickness of 1/16″.

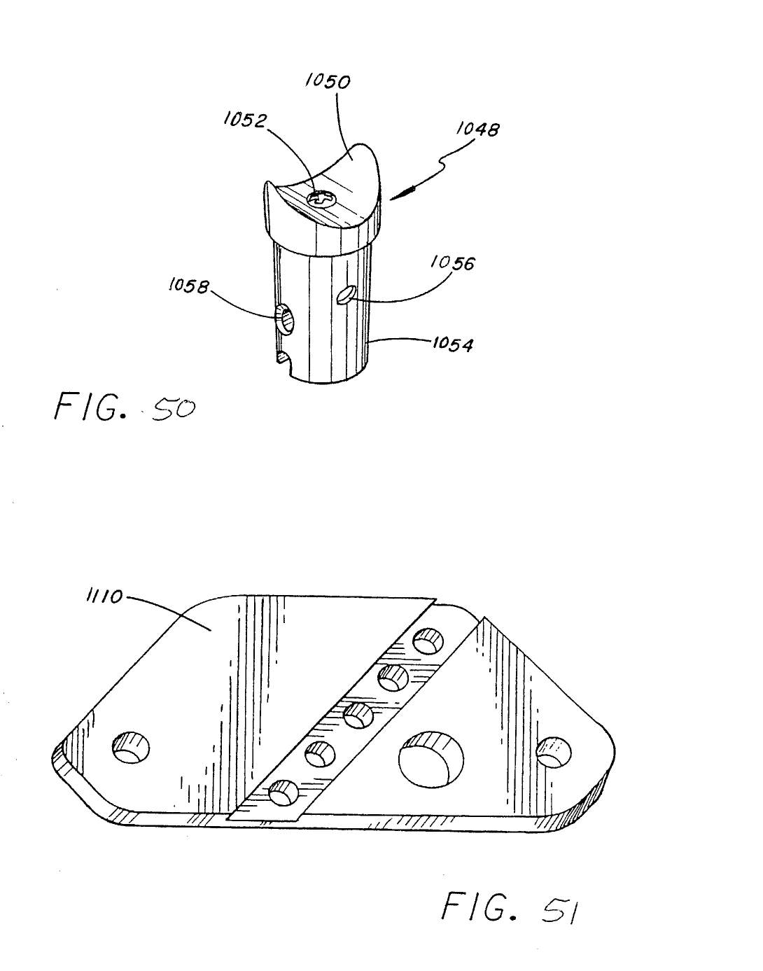

Extending from the end of member 1040 at juncture point 1046 is an end piece 1048. The end piece 1048 is shown in detail in FIG. 50. The end piece 1048 has a convex surface 1050 having a threaded bolt receptor 1052. The member 1048 also has a neck portion 1054 that is sized so as to fit within the tubing that forms a member of the side frame. A bolt aperture 1056 extends through the neck portion 1054 such that a bolt may be inserted through aperture 1056 to secure the member 1048 within the tube within which the member is to reside. An optional indentation 1058 may be provided to accommodate a spring-loaded pin type of retaining system.

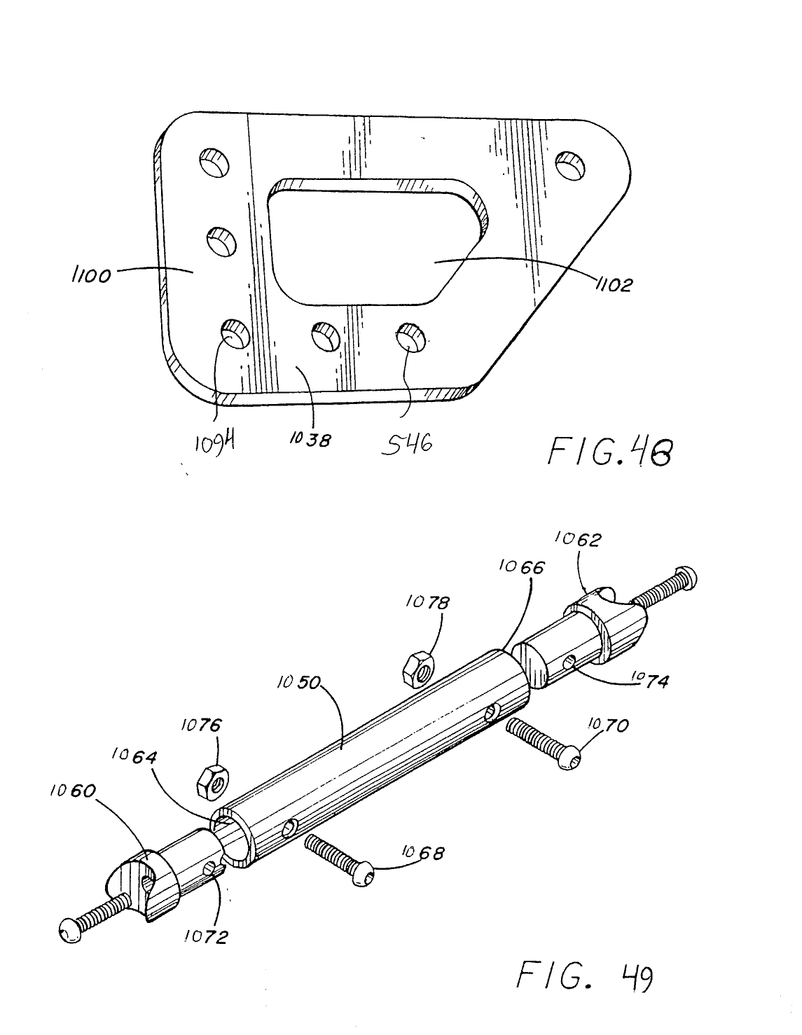

FIG. 49 illustrates how end pieces 1060 and 1062 are inserted into respective ends 1064 and 1066 of member 1050. Respective bolts 1068 and 1070 are inserted through opening in the tube 1050 through the apertures 1072 and 1074, respectively, in the members 1060 and 1062, and then through bottom openings in the tube 1050. Nuts 1076 and 1078 secure the bolts 1068 and 1070 into place.

Returning to FIG. 45, a bolt 1080 is inserted through the tubular member 1044 and into the end piece 1046 in order to interconnect member 1044 with upper member 1040. However, the end piece 1046 and bolt 1080 combination is only one means for securing the members 1040 and 1044 together. The upper and lower members are also secured together by way of an axle plate 1082, which extends between and is bolted to both members 1044 and 1040.

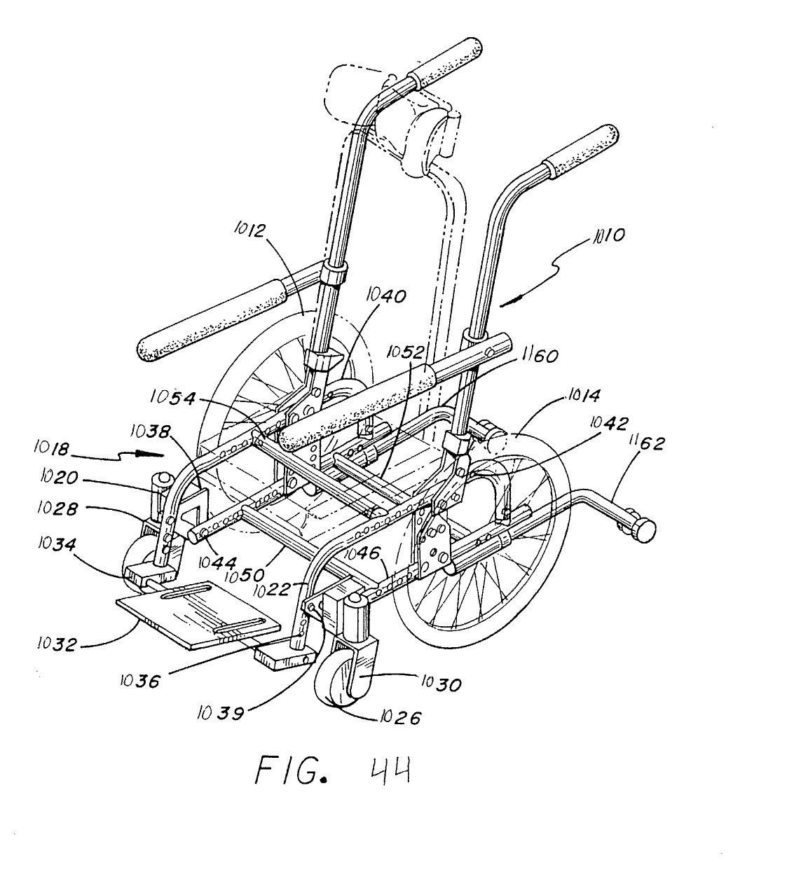

Referring to FIG. 46, the axle plate 1082 has a plurality of holes along each longitudinal side 1084 and 1086. This plurality of holes 84 and 86 provides the user with flexibility as to where the plate will be attached to the respective frame members 1040 and 1044. For example, if the spacing between members 1040 and 1044 in a particular embodiment is especially short, the user may use the same plate 1082 to join the two members together. The user simply reduces the spacing between the holes along the plurality of holes 1084 and 1086 and inserts bolts to hold the plate onto the frame members. In this way, the present system for interconnecting the members 1040 and 1044 is particularly versatile. Compared to systems in which members are welded, the use of the members such as 1082 greatly simplifies the manufacturing process. To modify the way in which members 1044 and 1040 are joined together, the user simply unbolts member 1082, and then is free to move member 1082 forward or backward as the situation requires. This flexibility is simply impossible in frames that are welded.

Considering member 1082 further, an elongated opening 1088 is provided through the center of member 1082. The opening 1088 is wide enough to accommodate an axle sheath receptor into which an axle may be inserted. The axle sheet receptor, as seen in FIG. 45, has reference numeral 1090 and serves to accommodate the axle of the wheel 1012 (not shown). An axle extension plate 1092 is bolted onto axle plate 1082 to provide means for retaining a wheel axle. The plate 1092 includes sets of holes or axle mounting apertures 1094 and 1096 and an alternative axle opening 1098 which can be used to accommodate a wheel axle in some embodiments of the invention. Like the axle plate 1082, the axle extension plate 1092 is designed to provide the user with considerable flexibility and adaptability. The plurality of holes 1094 and 1096 permit the user to vary the way in which the axle extension plate 1092 is mounted onto the axle plate 1082. In most embodiments, the axle extension plate 1092 is secured onto axle plate 1082 with four simple bolts. However, with the plurality of holes 1094 and 1096, the user can secure the axle extension plate 1092 onto the axle plate 1082 using more than four bolts, or potentially fewer bolts.

The axle extension plate 1092 serves to provide an axle sheath receptor 1090 for receiving and retaining a wheel axle. In an alternative embodiment, the axle plate 1082 may itself be provided with the axle sheath receptor 1090 so as to unify the functions of plates 1082 and 1092. However, in the presently preferred embodiment, a separate axle plate and an axle extension plate are employed.

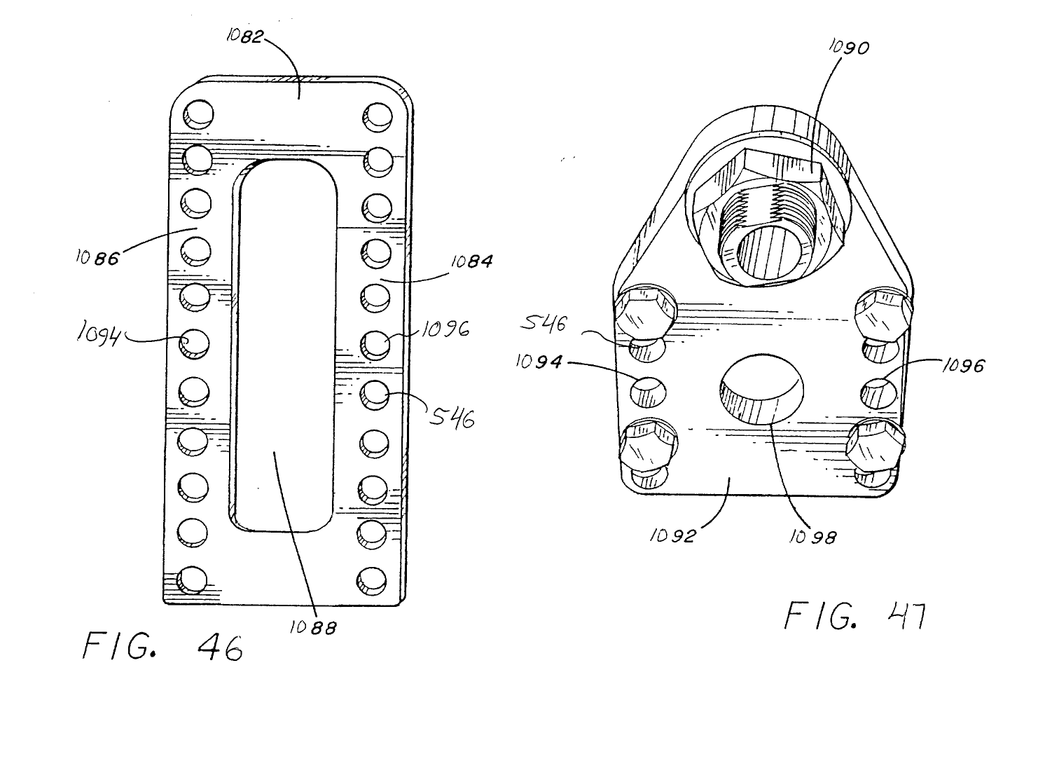

Returning now to FIG. 44, an additional means for securing the respective lower side frame members 1044 and 1046 to the respective upper side frame members 1040 and 1042 are caster plates 1038 and 1039, respectively. Turning to FIG. 48, a caster plate 1038 includes a plurality of bolt holes 1100 about the perimeter thereof. As with the axle plate 1082 and the axle extension plate 1092, the apertures in caster plate 1038 provide the user with considerable flexibility in manufacture. One caster plate 1038 may be used in any of variety in wheelchair designs because the plurality of bolt apertures 1100 provide the manufacturer with a variety of connection points from which to choose. The caster plate 1038 is provided with a central opening 1102 through which the respective caster 1028 may be mounted.

By way of illustrative dimensions, and not by limitation, the following components in one small wheelchair embodiment of the invention may have the following particular dimensions. It should be noted, however, that the present invention is not limited to any one embodiment. The wheels are approximately 16 inches in diameter. The lower sideframe members are approximately 17 inches long. The space between the left and right sideframes is approximately 10¼ inches. The space between the upper and lower side frame members is approximately 5 inches, as measured from the center of the upper tube to the center of the bottom tube, or 6 inches as measured from the bottom of the bottom tube to the top of the upper tube. The upper and lower sideframe members are hollow metal tubes having a diameter of approximately one inch. The axle plate is approximately 6¾ inches long by 2½ inches wide.

It is generally noted that the above dimensions pertain to a presently preferred embodiment of the invention. The structure of the sideframe design presented herein permits the very short spacing between the upper and lower sideframe members described above. The six-inch top-to-bottom sideframe spacing of the presently preferred embodiment is considered to be a noteworthy achievement in the art, particularly with the presently preferred adaptable, non-welded sideframe.

The foregoing has described one presently preferred embodiment of the present invention. However, it is to be understood that the present invention is not limited to any one embodiment. Consequently, various improvements and changes may be made. For example, the embodiment illustrated in FIG. 44 has the major wheels 1012 and 1014 mounted to the rear of the wheel chair and the minor caster wheels 1024 and 1026 mounted at the front of the wheelchair. However, in some embodiments, and especially in embodiments for small children, it is desirable to mount the major wheels 1012 and 1014 on the front of the wheelchair, and to move the smaller caster wheel 1024 and 1026 to the rear of the wheelchair. In such an embodiment, the anti tip members 1060 and 1062 will be mounted in the front, rather than the back of the wheelchair, such that the members 1060 and 1062 extend forwardly with the wheels thereof being in front of the wheelchair.

Thanks to the versatility of the present invention, it is a simple matter for a manufacturing standpoint to reconfigure the wheelchair into a forward wheel design. The respective axle plates and their corresponding axle extension plates are simply moved forward along their respective side frames and bolted to the front rather to the rear of the frame. To move the caster wheels 1026 and 1024 backwardly an additional caster plate is added to the rear of the frame. FIG. 51 illustrates a caster plate 1110 that can be added to the rear of the frame to support the casters 1028 and 1030. The caster plate 1110 is provided with a plurality of apertures for mounting the plate onto the side frame and for mounting the casters to the respective additional caster plates as illustrated in FIG. 51. In this alternative embodiment, it is preferred that the respective side frame portions 1040 and 1042 be provided with sufficient apertures along the rear portions thereof for mounting the additional caster plate.

Various other modifications may be made. For example, the one piece footrest 1032 may just be easily be broken into separate left and right footrests. The respective handles may be made to be foldable or rotatable forward, as desired.

The relative sizes of the wheels 1012 and 1014 may be made larger or smaller as the need arises. The design may be adapted to construct the folding wheelchairs described herein, for example, rather than the rigid configuration as shown.

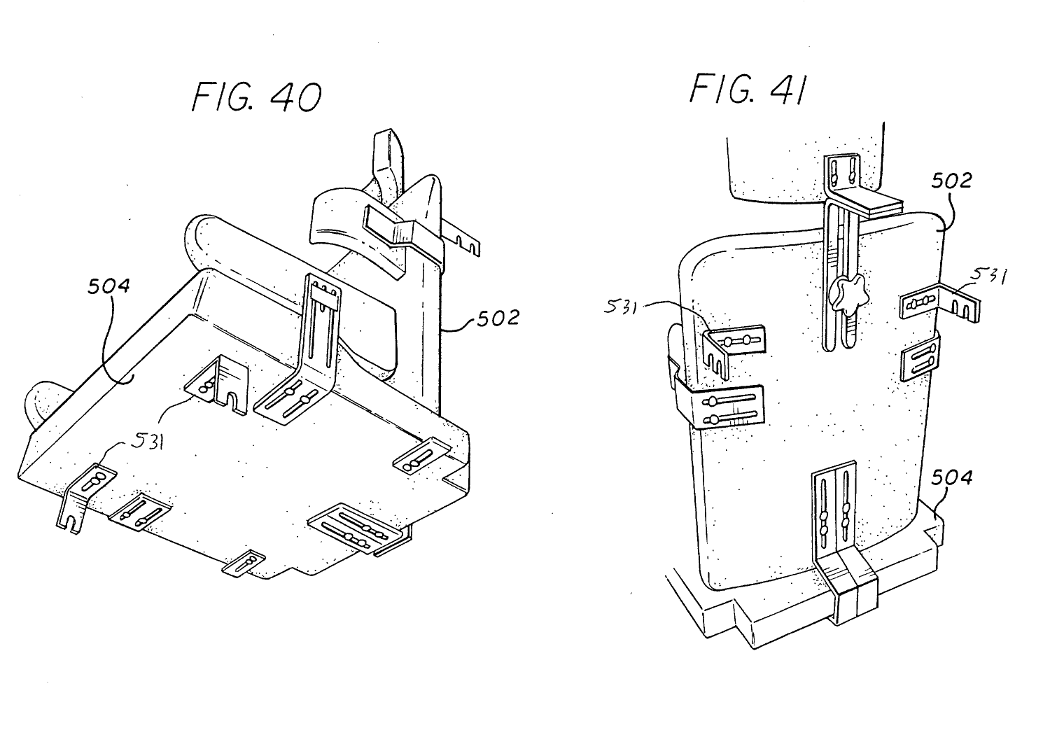

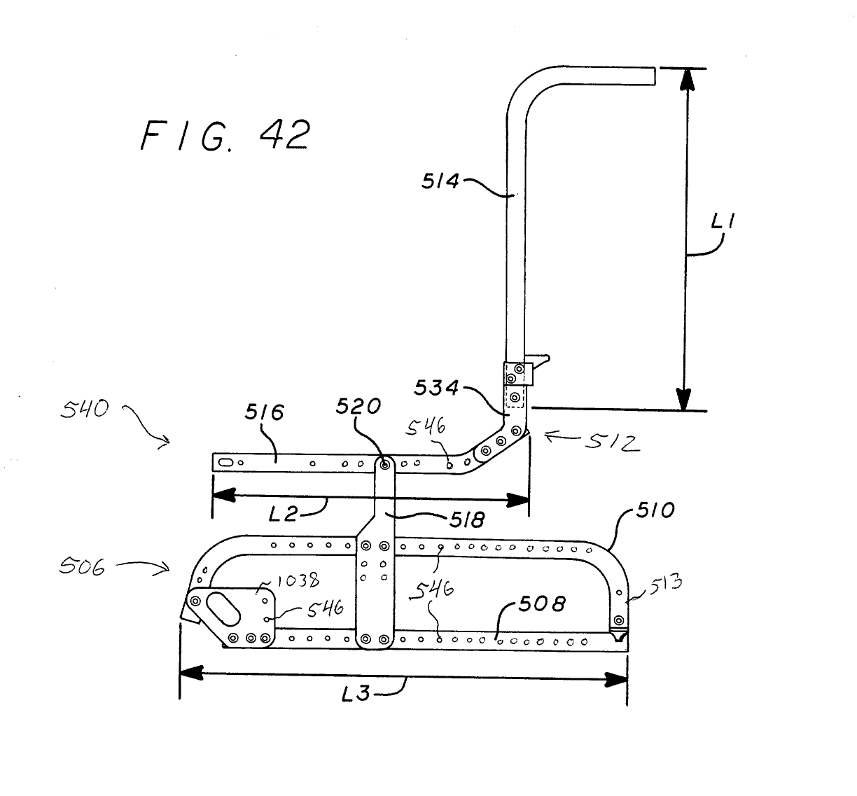

FIG. 42 shows a view of the collapsible frame 540 illustrating the size-adjustability feature that can be incorporated into all the embodiments described in the present disclosure. A person often needs to use a wheelchair from the time of childhood through adulthood. In such situations, where the person's size and/or shape changes, it has previously been necessary to purchase many new wheelchairs at great expense. The wheelchair of the present invention provides size adjustability to adjust to a person's changing size and/or shape, thus reducing the need to buy costly new wheelchairs.

In the wheelchair of the present invention, the lower base frame tubes 508, the upper base frame tubes 510, and the back posts 514 and the seat supporting tubes 516 can be individually replaced to adjust the size and/or shape of the wheelchair. For example, the replacement members can be selected to have the following large, medium, small, extra small and extra extra small lengths L1, L2 and L3 (measured in inches) as illustrated in FIG. 42:

| | L1 | L2 | L3 |
|---|---|---|---|
| Large | 25 | 22.5 | 29.25 |
| Medium | 22 | 20.5 | 27.25 |
| SM | 19 | 17.5 | 24.25 |
| XSM | | 15.5 | 22.25 |
| XXSM | | 12.5 | 19.25 |

The lengths of the lower base frame tubes 508 are adjusted to correspond to the length L3 desired for the upper base frame tubes 510. When the dimensions L1 or L2 are varied, the seat is also replaced to fit to the new dimensions. The replacements are performed by removing the bolts passing through the apertures, replacing the components and then replacing the bolts through the appropriate apertures.

Thus, if a child's torso becomes longer and her legs remain the same length, then the back posts 514 and the seat or just the seat-back can be replaced. There is then no need to replace any of the other members of the wheelchair or to buy a new wheelchair. Additionally, when the length L1 becomes so long as to make the chair unstable, the upper and lower base frame tubes 510 508 can be replaced with longer tubes to increase the dimension L3 to thereby make the wheelchair more stable.

The wheelchair can also be made more stable and at the same time accommodate a wider person by replacing the collapsible cross-frame 542 with a wider collapsible cross-frame. Thus the width of the wheelchair is also adjustable. The existing seat can be replaced with a wider seat for use with the wider wheelchair.

Smaller adjustments to the size and shape of the wheelchair are made by adjusting the positions of the upper and lower base frame tubes 510, 508, back posts 514, seat supporting tubes 516, tilt tube support brackets 518, and caster plates 1038 of FIG. 42. The relative positions of the multiple apertures illustrated in the figure are adjusted and secured by bolts to adjust the relative positions. For example, adjustments can be made to:

1) move the seat forward or back by moving the support brackets 518 forward or back relative to the base frame tubes 508, 510;

2) move the back posts 514 forward or back relative to the seat supporting tubes 516; and

3) adjust the attachment of the caster plates 1038 to the upper base frame tubes 510 to reduce or increase the height of the wheelchair (this also requires replacing the tilt tube support brackets 518 or adjusting the attachment of the support brackets 518 to the upper base frame tubes 510).

The back end of the upper base frame tube 510 can be formed so as not to contact the lower base frame tube 508. In such an embodiment the axle plate 548 of FIG. 35 or the axle plate 1082 of FIG. 45 can be used to support the base frame 506 and fix the height of the base frame. When adjusting the attachment of the caster plates 1038 to the upper base frame tubes 510 to reduce or increase the height of the wheelchair, the attachment of the axle plate 548 to the upper base frame tubes should also be adjusted. The positions of the caster plates 1038 and axle plates 548 can be adjusted along the length of the base frame 506 by aligning different apertures in order to adjust the balance of the wheelchair. Also, the positions of the caster plates 1038 and axle plates 548 can be exchanged with each other to switch between front and back drive wheelchairs.

It is to be understood that other embodiments may be utilized and structural and functional changes may be made without departing from the scope of the present invention. The foregoing descriptions of embodiments of the invention have been presented for the purposes of illustration and description. It is not intended to be exhaustive or to limit the invention to the precise forms disclosed. Accordingly, many modifications and variations are possible in light of the above teachings. It is therefore intended that the scope of the invention be limited not by this detailed description.

We claim:

1. A size adjustable collapsible and tilting seat wheelchair having a seat back releasably attached to back posts of the wheelchair and a seat releasably supported by a frame of the wheelchair, said wheelchair comprising:
means for tilting said seat and seat back on said wheelchair by manipulating said back posts;
means for collapsing said wheelchair frame when said seat and seat base are removed, said back posts being collapsible onto said frame; and
means of adjusting the location of said back posts and seat on said frame to adjust the wheelchair for varying sizes of users.

2. The wheelchair of claim 1 wherein wheels are mounted on said frame and means are provided for adjusting the location of mounting said wheels on said frame.

3. The wheelchair of clam 1 wherein said means for tilting said seat and said seat back comprises a tiltable seat supporting frame comprising right and left back posts and right and left seat supporting tubes, each said back post having a handle on one end and being interconnected with its respective seat supporting tube on another end, the tiltable seat supporting frame pivotally mounted onto said frame;

4. The wheelchair of claim 1 wherein said wheelchair frame includes right and left lower base frame tubes and right and left upper base frame tubes and said means for collapsing said wheelchair comprise:
a collapsible cross frame interconnecting said right and left base frame tubes, said collapsible cross frame comprising at least one cross member extending from one of said lower base frame tubes to the other of said upper base frame tubes, said cross member being pivotally mounted to each of said lower base frame and upper base frame tubes.

5. The wheelchair of claim 2 wherein said frame includes right and left lower base frame tubes and right and left upper base frame tubes and said means for adjusting the location of said back posts and seat comprise:
a plurality of tube mounting apertures disposed along the right and left lower base frame tubes and right and left upper base frame tubes.

6. The wheelchair of claim 2 wherein said frame includes right and left lower base frame tubes and right and left upper base frame tubes and said means for adjusting the location of said wheelchair comprises:
a plurality of tube mounting apertures disposed along the right and left lower base frame tubes and right and left upper base frame tubes;
pairs of front and rear axle mounting plates having axle mounting apertures corresponding to the tube mounting apertures;
wheels mounted to the base frame using the pairs of front and rear axle mounting plates; and
bolts passing through some of the tube mounting apertures and axle mounting apertures to removably secure the pairs of front and rear axle mounting plates to the base frame to allow for adjustment of the wheels relative to the base frame.

7. The wheelchair of claim 3 further comprising:
a support bracket for pivotally mounting the tiltable seat supporting frame onto said base frame; and
support bracket apertures passing through the support bracket for adjustably attaching the bracket to the base frame by passing at least one bolt through both a support bracket aperture a tube mounting aperture to allow for adjustment of the relative positions of the tiltable seat supporting frame and the base frame and to allow for adjustment of a tilting position of the seat relative to the base frame.

8. The wheelchair of claim 3 wherein said wheelchair frame includes right and left lower base frame tubes and the right and left upper base frame tubes wherein the base frame tubes, seats, back posts and seat supporting tubes are removable and substitutable with base frame tubes, seats, back posts and seat supporting tubes having different sizes to provide a size-adjustable wheelchair.
